(19) United States
(12) Patent Application Publication
(10) Pub. No.: US 2009/0073495 A1
(43) Pub. Date: Mar. 19, 2009

(54) IMAGE PROCESSING APPARATUS AND COMPUTER PROGRAM PRODUCT

(75) Inventor: Takeshi Ogawa, Yokohama-shi (JP)

Correspondence Address: COOPER & DUNHAM, LLP, 30 Rockefeller Plaza, 20th Floor, NEW YORK, NY, 10112, US

(73) Assignee: RICOH COMPANY, LTD, TOKYO (JP)

(21) Appl. No.: 12/208,945

(22) Filed: Sep. 11, 2008

(30) Foreign Application Priority Data
Sep. 14, 2007 (JP) 2007-239579
Nov. 26, 2007 (JP) 2007-305009

(51) Int. Cl. H04N 1/40

(52) U.S. Cl. 358/3.01

(57) ABSTRACT

An image processing apparatus quantizes multi-level image data of M gray levels into N-level image data (M>N>2) by using one of a multi-level error diffusion method to form an image by using a dot corresponding to each pixel included in the N-level image data, and includes various image processing units to obtain a correction value based on error values of neighboring pixels a target pixel, store quantized states of the neighboring pixels to set a threshold, compare the threshold with the correction value to determine the N-level image data, weight and diffuse an error generated with the N-level image data to the neighboring pixels of the target pixel. The image processing apparatus also includes an N-level processing unit to execute N-level processing and a binary processing unit configured to execute binary processing according to a dot type, and uses a weight matrix.

### TECHNICAL FIELD

Exemplary embodiments of the present patent specification relate to an image processing apparatus and a computer program product, and more particularly, to an image processing apparatus that performs printing processes for multi-level image data with high definition and multiple gradations, and a computer program product that can be used in the image processing apparatus.

### BACKGROUND

Related-art image input and output systems receive image data read by an input device such as a scanner and a digital camera, perform image processing operations onto the image data, and output the converted image data to an output device such as a printer and a display unit. During the image processing operations, the related-art image input and output systems convert image data of multiple levels (for example, 256 gray levels when each pixel is represented by 8 bits) read by the input unit to image data of given gray scale levels that can be output to the output unit to simulate continuous tones. Such method is called a dithering or digital halftoning.

In dithering or digital halftoning, binarization has been conducted when an output unit can only perform binary, or bi-level, (i.e., dot on/dot off) representation. An error diffusion technique and a minimized average error method are binary processes that have excellent resolution as well as gradation characteristics. The main difference between the error diffusion technique and the minimized average error method is in the timing of performing the error diffusion process, and thus, in the following, both of these techniques will be referred to as the error diffusion technique.

The error diffusion technique and the minimized average error method also differ as to whether or not error matrixes in units of pixels can be switched. Since the error diffusion technique diffuses errors quantized based on a target pixel, even though the error matrixes are switched in pixel units, the total number of quantization errors that are referenced in the target pixel is always 1. Therefore, the error matrixes can be switched freely. By contrast, the minimized average error method references quantization errors of neighboring pixels of a target pixel. Therefore, if an error matrix is switched during quantization of an image, the total number of quantization errors referenced by the target pixel may be not 1 but, for example, 0.95 or 1.21, and therefore the gray scale in a unit of an overall image cannot be stored.

In the error diffusion technique, M gray scale values may be quantized into not only binary levels but also tertiary levels or above. Similar to the binarization, such tertiary values or above can also have excellent resolution and gradation characteristics.

In electrophotographic processes, spatial frequency response may deteriorate in a MTF (Modulation Transfer Function) of a photoconductor, and each of an exposure process, a development process, a transfer process, and a fixing process. Therefore, even when an image structure with isolated dots is input as a record signal, there are variations in reproducibility, so that sufficient gray scale representation cannot be obtained. Specially, in the electrophotographic process that can write image data of multi-level image data such as tertiary-value image data (large and small dots) and quaternary-value image data (large, medium, and small dots), it is significantly difficult to keep reproducibility of isolated dots in a range of from a low gray scale area to a medium gray scale area.

Further, the error diffusion technique is a halftone process in which, when dots are output, quantization errors are diffused to neighboring pixels of a target pixel so as to disperse the dots according to density. Thus, multiple isolated dots are generated in the low to medium gray scale areas. Further, in a simple tertiary-level error diffusion process, gradation expression with small dots and dot-off holes is performed to fill up regions with the small dots spread, and then another gradation expression with small dots and large dots is performed. Accordingly, it is not suitable for electrophotography to employ a technique using small dots that have poor reproducibility.

To achieve stability in electrophotography, it is preferable to perform writing of binary image data. However, by employing tertiary-value image data or quaternary-value image data instead of binary image data, texture data may be improved. Further, one dot generated through the binary error diffusion process and a large dot generated through the tertiary-level or quaternary-level error diffusion process are equal. However, it is known that when a small dot or a medium dot is placed adjacent to the large dot to form a cluster, the large dot is less isolated than the one dot generated through the binary error diffusion, and therefore the stability can be achieved.

Therefore, in the electrophotographic process, gradation processes that can achieve good reproducibility even when writing multi-level image data (such as tertiary-value image data and quaternary-value image data) is performed is demanded.

In the related art, there have been a number of techniques developed in response to the above-described problems.

For example, in one technique, a threshold value is superimposed by dot concentration type dither noise so that each dot quantized by the error diffusion technique may concentrate as the dot concentration type dither noises superimposed on the threshold value. However, this technique cannot guarantee that small dots are not generated, and therefore unstable dot patterns may be generated depending on the image type.

Another technique involves an image forming method in which input data of an m-level halftone image is quantized to n-level image data (3≦n<m) by the error diffusion technique. With this technique, when the input data is a given level or above, the intervals of multiple threshold values are narrowed to reduce the probability of the occurrence of small dots. In this technique, small dots are not used in a high gray scale area to obtain the same image as obtained by the binary error diffusion process, thereby stabilizing image quality. However, this technique is not suitable for a low gray scale area since the small dots are isolated.

In yet another technique, quantized states of neighboring pixels of a target pixel are referenced determine whether or not a dot pattern becomes stable. One error diffusion process that employs this technique converts an output value of a target pixel position to a dot other than the small dot when unstable small dots of neighboring pixels of the target pixel are placed in a main scanning direction. This process can prevent continuous use of the unstable neighboring pixels in the main scanning direction. However, since the isolation of small dots is not ensured in the low gray scale area, it is possible that an electrophotographic image forming apparatus produces images with instability in quality.

In a multi-level error diffusion process that employs this technique, small dots are controlled to be output between dot-off holes in the main scanning direction. That is, the small dots may not appear in gray scale levels that cannot express such small dots, and therefore stability in image quality can be achieved in the medium and high gray scale areas. However, all small dots are isolated in the main scanning direction in the low gray scale area. Therefore, the small dots may be stable only when they reside in a sub-scanning direction in the low to medium gray scale areas, which may produce dot patterns unsuitable for electrophotography.

Another error diffusion process that employs this technique sets a threshold value according to quantized states of neighboring pixels of a target pixel so that dots can form clusters easily. This process can cause dots to easily concentrate in the medium to high gray scale areas in the binary error diffusion process. However, this process cannot be used in the tertiary-level or quaternary-level error diffusion process; otherwise, a cluster is formed with small dots in the low gray scale area to fill up the region with the small dots, and then medium dots are used. Accordingly, an image part produced in the low gray scale area can be significantly unstable.

Therefore, it has been demanded to provide a gradation process with good reproducibility even when multi-level (tertiary-level or quaternary-level) writing is performed in an electrophotographic process. However, there have been many cases where such gradation process are unsuitable for an electrophotographic device such as a plotter or in the low gray scale area.

### SUMMARY

Example aspects of the present patent specification have been made in view of the above-described circumstances.

Example aspects of the present patent specification provide an image processing apparatus that can prevent poor image reproducibility due to dots by controlling thresholds according to quantized data in the proximity to a target pixel.

Other example aspects of the present patent specification provide a computer program product that includes a computer usable medium having computer readable program codes embodied in he medium that, when executed, causes a computer to execute an image processing method used in the above-described image processing apparatus.

In one exemplary embodiment, an image processing apparatus is configured to quantize multi-level image data of M gray levels into N-level image data (M>N>2) by using one of a multi-level error diffusion method and a multi-level minimized average error method to form an image by using a dot corresponding to each pixel included in the N-level image data. The image processing apparatus includes an adder configured to add the sum of products of weighted error values of neighboring pixels already quantized to multi-level image data of a target pixel to output a correction value, a quantization memory configured to store quantized states of the neighboring pixels of the target pixel, a threshold setting unit configured to set a threshold value according to the quantized states stored in the quantization memory, a comparison and determination unit configured to compare the threshold value with the correction value and determine the N-level image data, a subtractor configured to obtain an error generated with the N-level image data, an error diffusion unit configured to weight and diffuse the error to the neighboring pixels of the target pixel, and an error memory configured to store the weighted and diffused error.

The above-described image processing apparatus may include a variable threshold setting unit configured to set a variable threshold value according to the multi-level image data of the target pixel. The threshold setting unit may set the threshold value according to the quantized states and the variable threshold value.

The variable threshold value obtained according to the multi-level image data of the target pixel may include N-1 threshold values, and the N-1 threshold values may be different in low and medium gray scale area, gradually become closer to each other as the gray scale becomes higher, and become equal to each other in a high gray scale area.

The above-described image processing apparatus may further include a quantized reference unit configured to output a weighted average value obtained by the sum of products of the quantized states of the neighboring pixels of the target pixel, and a history value calculation unit configured to calculate a history value based on the weighted average value. The threshold setting unit may set the threshold according to the quantized states and the history value.

The above-described image processing apparatus may further include a history coefficient setting unit configured to set a history coefficient according to the multi-level image data of the target pixel. The history value calculation unit may calculate the history value based on the weighted average value and the history coefficient.

The above-described image processing apparatus may further include a variable threshold setting unit configured to set a variable threshold value according to the multi-level image data of the target pixel. The threshold setting unit may set the threshold according to the quantized states, the history value, and the variable threshold value.

The history coefficient obtained according to the image data of the target pixel may be high in a low gray scale area of the image data and may be low in a high gray scale area of the image data.

An image forming system may include the above-described image processing apparatus, an image input apparatus configured to input the multi-level image data of the target pixel to the image processing apparatus, and an image forming apparatus configured to form the N-level image data. The image processing apparatus is incorporated in one of the image input apparatus and the image forming apparatus.

Further, in one exemplary embodiment, an image processing apparatus quantizes multi-level image data of M gray levels into N-level image data (M>N>2) by using one of a multi-level error diffusion technique and a multi-level minimized average error method. The image processing apparatus includes an N-level processing unit configured to execute N-level processing when a large dot is output at a position of a pixel adjacent to a target pixel, and a binary processing unit configured to execute binarization when a dot other than a large dot is output at a position of a pixel adjacent to the target pixel, and uses a weight matrix when performing error diffusion.

The weight matrix may include a coefficient of 0 or below at a position of a neighboring pixel of the target pixel.

A weight matrix including a coefficient of 0 or below at a position of a neighboring pixel of the target pixel may be used when a large dot is output through binarization, and a normal weight matrix may be used when a dot-off hole is output through binarization or when the N-level processing is executed.

The multi-level image data may be quantized into the N-level image data (M>N>2) using the multi-level error diffusion method to form an image by using a dot corresponding to each pixel included in the N-level image data. The above-described image processing apparatus may further include an adder configured to add the sum of products of weighted error values of neighboring pixels already quantized to multi-level image data of a target pixel to output a correction value, a quantization memory configured to store quantized states of the neighboring pixels of the target pixel, a threshold setting unit configured to set a threshold value according to the quantized states stored in the quantization memory, a comparison and determination unit configured to compare the threshold value with the correction value and determine the N-level image data, a subtractor configured to obtain an error generated with the N-level image data, an error diffusion unit configured to weight and diffuse the error to the neighboring pixels of the target pixel by using the weight matrix including the coefficient of 0 or smaller at the pixel positions of the neighboring pixels of the target pixel, and an error memory configured to store the weighted and diffused error.

The above-described image processing apparatus may further include an error diffusion coefficient setting unit configured to select one weight matrix among multiple weight matrixes according to the quantized states of the neighboring pixels of the target pixel and the N-level image data, an error diffusion unit configured to weight and diffuse the error to the neighboring pixels of the target pixel by using the selected weight matrix, and an error memory configured to store the weighted and diffused error.

The above-described image processing apparatus may further include a variable threshold setting unit configured to set a variable threshold value according to the multi-level image data of the target pixel, a threshold setting unit configured to set a threshold value according to the quantized states stored in the quantization memory and the variable threshold value, an error diffusion unit configured to weight and diffuse the error to the neighboring pixels of the target pixel by using the weight matrix including the coefficient of 0 or smaller at the pixel positions of the neighboring pixels of the target pixel, and an error memory configured to store the weighted and diffused error.

The variable threshold value obtained according to the multi-level image data of the target pixel may include N-1 threshold values. The N-1 threshold values may be different in low and medium gray scale area, gradually become closer to each other as the gray scale becomes higher, and become equal to each other in a high gray scale area.

The above-described image processing apparatus may further include an error diffusion coefficient setting unit configured to select one weight matrix among multiple weight matrixes according to the quantized states of the neighboring pixels of the target pixel and the N-level image data, and an error diffusion unit configured to weight and diffuse the error to the neighboring pixels of the target pixel by using the selected weight matrix.

The one weight matrix selected from the multiple weight matrixes may be a matrix including a coefficient of 0 or smaller at the pixel positions of the neighboring pixels of the target pixel while another weight matrix of the multiple weight matrixes may be a matrix including a coefficient being large to positive error at the pixel positions of the neighboring pixels of the target pixel and the coefficient gradually becoming smaller as becoming farther from the target pixel.

An image forming system may include the above-described image processing apparatus, an image input apparatus configured to input the multi-level image data of the target pixel to the image processing apparatus, and an image forming apparatus configured to form the N-level image data. The image processing apparatus may be incorporated in one of the image input apparatus and the image forming apparatus.

Further, in one exemplary embodiment, a computer program product includes including a computer-usable medium having computer-readable program codes embodied in the medium that, when executed, causes a computer to execute an image processing method that includes adding the sum of products of weighted error values of neighboring pixels already quantized to multi-level image data of a target pixel to output a correction value, storing quantized states of the neighboring pixels of the target pixel, setting a threshold value according to the stored quantized states, comparing the threshold value with the correction value and determine the N-level image data, obtaining an error generated with the N-level image data, weighting and diffusing the error to the neighboring pixels of the target pixel, and storing the weighted and diffused error.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic configuration diagram of an image forming system according to an exemplary embodiment of the present patent specification;

FIG. 2 is a schematic configuration of an image forming apparatus, according to an exemplary embodiment of the present patent specification, of the image forming system of FIG. 1;

FIG. 3 is a schematic configuration of a laser light unit included in the image forming apparatus of FIG. 2;

FIG. 4 is a diagram of a large dot and a small dot to be represented by using PWM signals;

FIG. 5 is a schematic configuration diagram of an image processing apparatus, included in the image forming system of FIG. 1, according to first and sixth exemplary embodiments of the present patent specification;

FIG. 6 is a matrix with reference coefficients;

FIG. 7 is a schematic configuration diagram of an image processing apparatus according to second and seventh exemplary embodiment of the present patent specification;

FIG. 8 is a graph showing various threshold values obtained according to input value;

FIG. 9 is a schematic configuration diagram of an image processing apparatus according to a third exemplary embodiment of the present patent specification;

FIG. 10 is another matrix with reference coefficients;

FIG. 11 is a schematic configuration diagram of an image processing apparatus according to a fourth exemplary embodiment of the present patent specification;

FIG. 12 is a graph showing a history coefficient obtained according to input value;

FIG. 13 is a schematic configuration diagram of an image processing apparatus according to a fifth exemplary embodiment of the present patent specification;

FIG. 14 is another matrix with reference coefficients;

FIG. 15 is another matrix with reference coefficients;

FIG. 16 is another matrix with reference coefficients;

FIG. 17 is a schematic configuration diagram of an image processing apparatus according to an eight exemplary embodiment of the present patent specification; and

FIG. 18 is a schematic configuration diagram of an image processing apparatus according to a ninth exemplary embodiment of the present patent specification.

### DETAILED DESCRIPTION OF EXEMPLARY EMBODIMENTS

In describing exemplary embodiments illustrated in the drawings, specific terminology is employed for the sake of clarity. However, the disclosure of the present patent specification is not intended to be limited to the specific terminology so selected and it is to be understood that each specific element includes all technical equivalents that operate in a similar manner.

Referring now to the drawings, wherein like reference numerals designate identical or corresponding parts throughout the several views, preferred embodiments of the present patent specification are described.

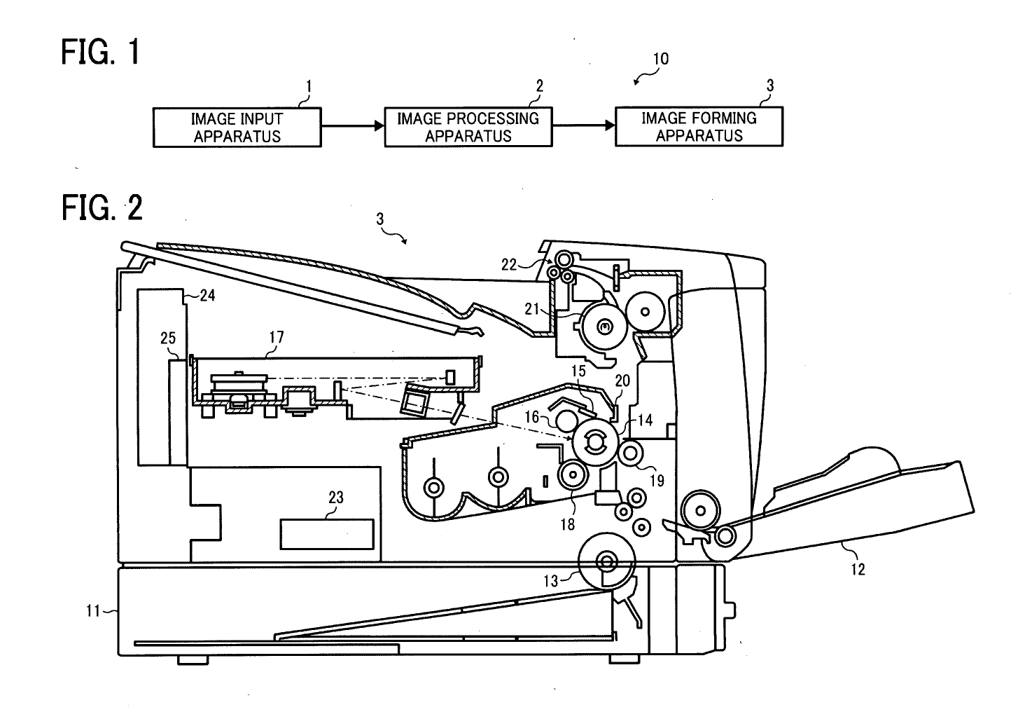

FIG. 1 is a schematic configuration diagram of an image input/output system or image forming system 10 according to an exemplary embodiment of the present patent specification. The image forming system 10 includes an image input apparatus 1, an image processing apparatus 2, and an image forming apparatus 3.

The input device 1 of FIG. 1 corresponds to a scanner, a digital camera, and the like. For example, when each pixel is represented by 8 bits, an input image is input as image data having 256 gray levels. The multi-level image data is input to the image processing apparatus 2 according to an exemplary embodiment of the present patent specification.

In FIG. 1, the image input apparatus 1, the image processing apparatus 2, and the image forming apparatus 3 of the image input/output system 10 are individually arranged according to respective processes. However, the configuration of the image input/output system 10 is not limited to the configuration as shown in FIG. 1. For example, in the image input/output system 10, the functions or processes performed in the image processing apparatus 2 can be performed in the image input apparatus 1 or the image forming apparatus 3.

The image processing apparatus 2 performs processes to convert the image data having 256 gray levels input by the image input apparatus 1 to a given number of gray scale levels to output the image data in the following image forming apparatus 3.

To convert the gray scale level, the multi-level error diffusion technique or the multi-level minimized average error method can be used.

The image data quantized by the image processing apparatus 2 is transmitted to the image forming apparatus 3 as shown in FIG. 2. The image forming apparatus 3 corresponds to a printer or other image output unit. A process method according to an exemplary embodiment of the present patent specification can be applied to the image forming apparatus 3 so as to record or form images by using an inkjet method or a gravure printing technique.

FIG. 2 is a schematic configuration of the image forming apparatus 3 according to an exemplary embodiment of the present patent specification.

In the image forming apparatus 3 shown in FIG. 2, a transfer sheet serving as a recording medium on which an image is formed is set in a main tray 11 or on a manual feed tray 12. The transfer sheet is fed by a sheet feeding roller from one of the main tray 11 and the manual feed tray 12.

A photoconductor or photoconductive drum 14 rotates prior to the conveyance of the transfer sheet by a sheet feeding roller 13. The photoconductor 14 is disposed surrounded by a cleaning blade 15, a charge roller 16, a developing roller 18, a transfer roller 19, and the like. The cleaning blade 15 cleans a surface of the photoconductor 14 before the charge roller 16 uniformly charges the surface thereof.

A laser light unit 17 that is disposed at a position horizontally higher than the photoconductor 14 emits a laser light bean modulated based on an image signal to irradiate the surface of the photoconductor 14 so as to form a latent image on the surface of the photoconductor 14, and the developing roller 18 supplies toner to the photoconductor 14 to develop the latent image to a visible toner image. In synchronization with the above-described movement, the transfer sheet is fed by the sheet feeding roller 13.

The transfer sheet fed from the sheet feeding roller 13 is conveyed while being sandwiched by the photoconductor 14 and the transfer roller 19, and at the same time the toner image is transferred onto the transfer sheet. Residual toner remaining on a surface of the photoconductor 14 is scraped and removed by the cleaning blade 15 to repeat the above-described action.

A toner density sensor 20 is disposed upstream from the cleaning blade 15 in a direction of rotation of the photoconductor 14. The toner density sensor 20 measures the density of the toner image formed on the surface of the photoconductor 14.

The transfer sheet having the toner image thereon is conveyed along a sheet transfer path to a fixing unit 21. The fixing unit 21 fixes the toner image onto the transfer sheet. The transfer sheet with the fixed image passes through a sheet discharging roller 22 to be output to an outside the image forming apparatus 3 with face down in an order of pages.

The laser light unit 17 is connected to a video controller 24, a LD drive circuit 25, and the like. The video controller 24 controls image signals input from an external personal computer, workstation, etc., or generates evaluation chart signals or test pattern signals held inside the laser light unit 17. Further, a bias circuit 23 applies high voltage bias to the developing roller 18. By controlling the bias in the bias circuit 23, the overall density of an image may be controlled.

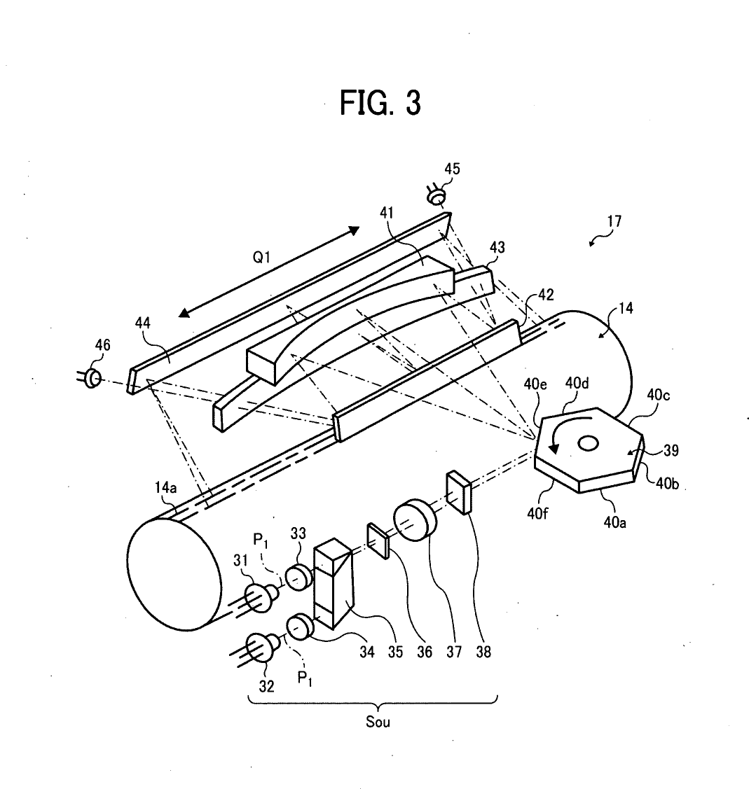

FIG. 3 shows a schematic configuration of the laser light unit 17 to describe a relative position of the laser light unit 17 to the photoconductor 14 serving as an image carrier to which the laser light beam is emitted.

The laser light unit 17 of FIG. 3 includes optical components such as laser diodes or semiconductor lasers 31 and 32, collimating lenses 33 and 34, an optical member for forming a light path 35, ¼ retardation plate 36, and beam forming optical systems 37 and 38. These optical components 31 to 38 form a laser light source (light beam source) Sou. The laser light source Sou emits two light beams P1. The light beams P1 pass through the collimating lenses 33 and 34, respectively, to form a parallel light flux.

The laser light unit 17 further includes a polygon mirror 39 that has surfaces 40a to 40f. The polygon mirror 39 is a part of an optical scanning system of the laser light unit 17. The parallel light flux is guided to the polygon mirror 39 so that the surfaces 40a to 40f of the polygon mirror 39 can reflect the parallel light flux to be deflected in a main scanning direction Q1.

The deflected light beam is guided to reflection mirrors 41 and 42, which form a part of an f-theta optical system 43 of the laser light unit 17. The light beam deflected by the reflection mirrors 42 passes through the f-theta optical system 43 to be guided to a slanted reflection mirror 44. The slanted reflection mirror 44 guides the deflected light beam to a surface 14a of the photoconductor 14 that serves as an image carrier. The light beam scans the surface 14a of the photoconductor 14 linearly in the main scanning direction Q1 to write an image on the surface 14a.

The laser light unit 17 further includes synchronizes sensors 45 and 46 disposed at both sides in a longitudinal direction of the reflection mirror 44 or in the main scanning direction Q1 of the laser light beam. The synchronized sensor 45 is used to determine a timing to start an image writing operation, and the synchronized sensor 46 is used to determine a timing to end the image writing operation.

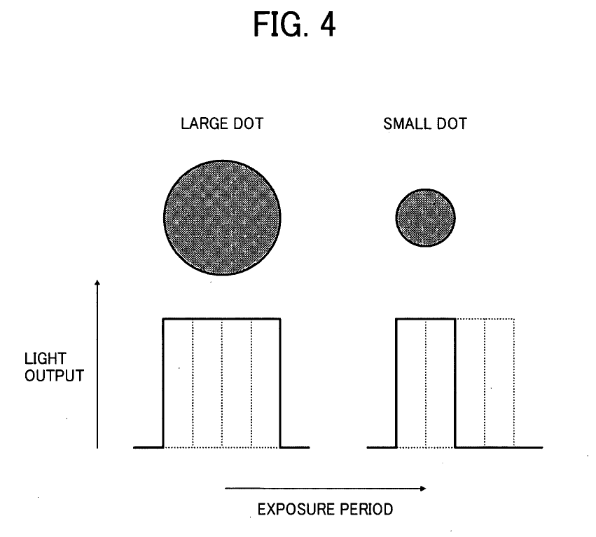

Now, the image forming apparatus 3 shown in FIG. 1 uses a PWM (Pulse Width Modulation) signal to vary the pulse duty so as to reproduce large dots and small dots as shown in FIG. 4. Respective gray scale values of a large dot and a small dot are 255 and 128, respectively.

The image input apparatus 1, the image processing apparatus 2, and the image forming apparatus 3 of the image input/output system 10 shown in FIG. 1 have been described as an individual device according to processes. However, as previously described, the configuration of the image input/output system 10 is not limited thereto, and the functions of the image processing apparatus 2 can be equipped to the image input apparatus 1 or the image output apparatus or image forming apparatus 3.

### First Exemplary Embodiment

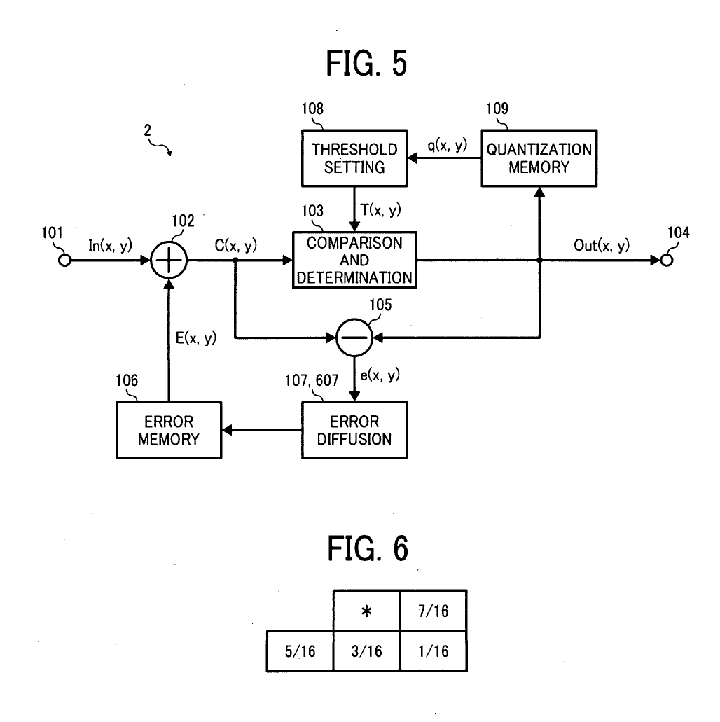

FIG. 5 shows a schematic configuration diagram of the image processing apparatus 2 according to a first exemplary embodiment.

Multi-level image data from the image input apparatus 1 is input to an input terminal 101 of the image processing apparatus 2. Hereinafter, the multi-level image data input from the image input apparatus 1 is referred to as “input data In(x,y)” to indicate that it is two-dimensional image data, where “x” represents an address of an image in a main scanning direction and “y” represents an address of the image in a sub-scanning direction.

The input data In(x,y) is then input to an adder 102. The adder 102 adds an error element E(x,y) input from an error memory 106 to the input data In(x,y) to obtain correction data C(x,y), and outputs the correction data C(x,y) to a comparison and determination unit 103 and a subtractor 105.

The comparison and determination unit 103 compares and determines an output value Out(x,y) based on the correction data C (x,y) input from the adder 102 and a threshold group T (x,y) input from a threshold setting unit 108, as Equation 1 shown below. The threshold group T (x,y) is a group including a first threshold value T1(x,y) and a second threshold value T2(x,y). The first threshold value T1(x,y) is a threshold value to determine whether a dot to be output is a dot-off or a small dot. The second threshold value T2(x,y) is a threshold value to determine whether a dot to be output is a small dot or a large dot.

$$If ( C ( x , y ) < T 1 ) \\ then Out ( x , y ) = 0 \\ Else If ( C ( x , y ) < T 2 ) \\ then Out ( x , y ) = 128 \\ Else \\ then Out ( x , y ) = 255. \qquad Equation 1$$

The output value Out(x,y) obtained through the above-described process is output from an output terminal 104 to the image forming apparatus 3.

The output value Out(x,y) is also input to a quantization memory 109 and the subtractor 105.

The subtractor 105 subtracts the output value Out(x,y) from the correction data C(x,y) to obtain an error e(x,y), as Equation 2 shown below. Accordingly, the error e(x,y) generated in a present target pixel can be calculated.

e(x,y)=C(x,y)−Out(x,y) Equation 2.

The error e(x,y) is input to an error diffusion unit 107. The error diffusion unit 107 distributes or diffuses the error e(x,y) based on a diffusion coefficient given in advance so as to add the error e(x,y) to error data E(x,y) stored in the error memory 106.

For example, FIG. 6 shows coefficients of an error matrix.

When the coefficients shown in FIG. 6 are used as diffusion coefficients, the error diffusion unit 107 executes processes of the following Equation 3.

E(x+1,y)=E(x+1,y)+e(x,y)× 7/16,

E(x−1,y+1)=E(x−1,y+1)+e(x,y)× 5/16,

E(x,y+1)=E(x,y+1)+e(x,y)× 3/16, and

E(x+1,y+1)=E(x+1,y+1)+e(x,y)× 1/16. Equation 3.

The quantization memory 109, which stores the output value Out(x,y) of the target pixel, outputs a quantum group q(x,y) that includes multiple quantized states of multiple pixels near the target pixel to the threshold setting unit 108. Here, the quantization memory 109 outputs output values of two pixels adjacent to the target pixel (x,y) as the quantum group q(x,y). Specifically, the quantization memory 109 outputs the quantum group q(x,y) including an output value Out(x−1,y) of an adjacent pixel (x−1,y) and an output value Out(x,y−1) of an adjacent pixel (x,y−1).

The threshold setting unit 108 use the following Equation 4 by using the quantum group q(x,y), which includes the output value Out(x−1,y) of the adjacent pixel (x−1,y) and the output value Out(x,y−1) of the adjacent pixel (x,y−1), input from the quantization memory 109, so as to set the threshold group T(x,y) including the first threshold value T1(x,y) and the second threshold value T2(x,y) of a position of the target pixel and output the threshold group T(x,y) to the comparison and determination unit 103.

$$If ( Out ( x - 1 , y ) = 255 ) \\ then T 1 ( x , y ) = 64 , \\ T 2 ( x , y ) = 127 \\ Else If ( Out ( x , y - 1 ) = 255 \\ then T 1 ( x , y ) = 64 , \\ T 2 ( x , y ) = 127 \\ Else \\ then T 1 ( x , y ) = 127 , \\ T 2 ( x , y ) = 127. \qquad Equation 4$$

As described above, the multi-level error diffusion process is executed by the configuration of the image processing apparatus 2.

By performing the above-described process according to the first exemplary embodiment, the following effects can be obtained.

As shown in Equation 4, the first threshold value T1(x,y) may be either 64 or 127 depending on the output values Out(x−1,y) and Out(x,y−1) of the adjacent pixels (x−1,y) and (x,y−1) residing near the target pixel.

When both of the output values of the two pixels neighboring the target pixel are not for outputting large dots, the first threshold value T1(x,y) and the second threshold value T2(x,y) are calculated as 127. In this case, only dot-off holes or large dots may be output, which is same as a binary-level error diffusion, and isolated small dots may not be output.

Only when at least one output value of the two pixels neighboring the target pixel is calculated as 255, which indicates a large dot, a calculated value of the first threshold value T1(x,y) may be different from a calculated value of the second threshold value T2(x,y).

At this time, large dots are output to the adjacent pixels, and therefore the dots are less likely to be generated and output due to the diffusion of a negative error values. However, if sufficient errors are accumulated, smaller dots can be output. Even though it is difficult to output dots in a low gray scale area, small dots can be output adjacent to the large dots in medium and high gray scale areas.

In the first exemplary embodiment, the threshold setting unit 108 employs the output values Out(x−1,y) and Out(x,y−1) of the adjacent pixels residing adjacent to the target pixel. However, the setting of the threshold setting unit 108 can be changed according to stability of an output unit. For example, when using an output unit that can stabilize pixels residing not only in the main scanning direction and the sub-scanning direction but also residing sequentially on an upper or lower right hand side and an upper or lower left hand side, output values of pixels on the upper right hand side and the upper left hand side, such as output values Out(x+1,y−1) and Out(x−1,y−1), with respect to the target pixel can be set to be referenced.

The first exemplary embodiment of the present patent specification has been explained for a tertiary-level error diffusion. However, the present patent specification can be applied for a quaternary-level error diffusion. The quaternary-level error diffusion uses three threshold values: a first threshold value T1(x,y) is a threshold value to determine whether dot-off holes or small dots are output; a second threshold value T2(x,y) is a threshold value to determine whether small dots or medium dots are output; and a third threshold value T3(x,y) is a threshold value to determine whether medium dots or large dots are output. For the quaternary-level error diffusion, Equation 4 can be modified to the following Equation 4′. That is, when large dots are not output to any pixel of the output values of the neighboring pixels of the target pixel, the first threshold value T1(x,y), the second threshold value T2 (x,y), and the third threshold value T3(x,y) may be made equal so as to convert to the binary error diffusion. By contrast, when large dots are output to one or more pixels of the output values of the neighboring pixels of the target pixel, the first threshold value T1(x,y), the second threshold value T2 (x,y), and the third threshold value T3(x,y) may be made different from each other.

$$If ( Out ( x - 1 , y ) = 255 ) \\ then T 1 ( x , y ) = 43 , \\ T 2 ( x , y ) = 128 , \\ T 3 ( x , y ) = 213 \\ Else If ( Out ( x , y - 1 ) = 255 \\ then T 1 ( x , y ) = 43 , \\ T 2 ( x , y ) = 128 , \\ T 3 ( x , y ) = 213 \\ Else \\ then T 1 ( x , y ) = 127 , \\ T 2 ( x , y ) = 127 , \\ T 3 ( x , y ) = 127. \qquad Equation {4}^{′}$$

As described above, by referencing the quantized states of the neighboring pixels of the target pixel to set a threshold value, dots smaller than the large dots (i.e., smaller dots and medium dots) can be output adjacent to the large dots. Accordingly, texture may be improved in the medium and high gray scale areas and images having good reproducibility can be obtained.

### Second Exemplary Embodiment

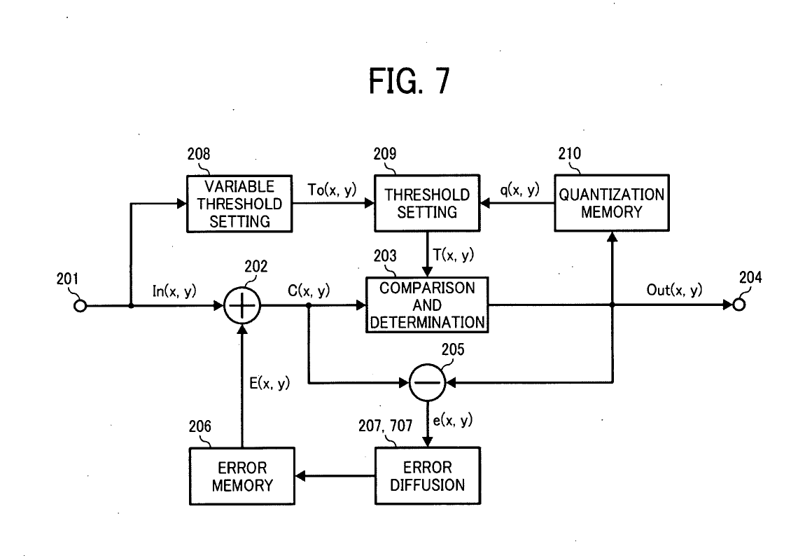

FIG. 7 shows a schematic configuration diagram of the image processing apparatus 2 shown in FIG. 1, according to a second exemplary embodiment of the present patent specification.

Multi-level image data from the image input apparatus 1 is input to an input terminal 201 of the image processing apparatus 2. Hereinafter, the multi-level image data input from the image input apparatus 1 is referred to as “input data In(x,y)” to indicate that it is two-dimensional image data, where “x” represents an address of an image in a main scanning direction and “y” represents an address of the image in a sub-scanning direction.

The input data In(x,y) is then input to an adder 202 and a variable threshold setting unit 208. The adder 202 adds an error element E(x,y) input from an error memory 206 to the input data In(x,y) to obtain correction data C(x,y), and outputs the correction data C(x,y) to a comparison and determination unit 203 and a subtractor 205.

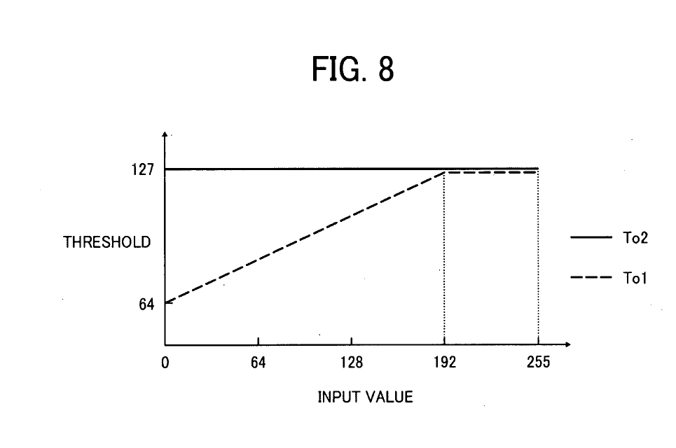

The variable threshold setting unit 208 sets a variable threshold group To(x,y) including a first variable threshold value To1(x,y) and a second variable threshold value To2(x,y) according to the input data In(x,y) as shown in FIG. 8, and outputs the variable threshold group To(x,y) to a threshold setting unit 209.

The comparison and determination unit 203 compares and determines an output value Out(x,y) based on the correction data C (x,y) input from the adder 202 and a threshold group T (x,y) input from a threshold setting unit 209, as shown in Equation 1. The output value Out(x,y) obtained through the above-described process is output from an output terminal 204 to the image forming apparatus 3.

The output value Out(x,y) is also input to a quantization memory 210 and the subtractor 205.

The subtractor 205 subtracts the output value Out(x,y) from the correction data C(x,y) to obtain an error e(x,y), as shown in Equation 2. Accordingly, the error e(x,y) generated in a present target pixel can be calculated.

The error e(x,y) is input to an error diffusion unit 207. The error diffusion unit 207 distributes or diffuses the error e(x,y) as shown in Equation 3 so as to add the error e(x,y) to error data E(x,y) stored in the error memory 206.

The quantization memory 210, which stores the output value Out(x,y) of the target pixel, outputs a quantum group q(x,y) that includes multiple quantized states of multiple pixels near the target pixel to the threshold setting unit 209. Here, the quantization memory 210 outputs output values of two pixels adjacent to the target pixel (x,y) as the quantum group q(x,y). Specifically, the quantization memory 210 outputs the quantum group q(x,y) including an output value Out(x−1,y) of an adjacent pixel (x−1,y) and an output value Out(x,y−1) of an adjacent pixel (x,y−1).

The threshold setting unit 209 use the following Equation 5 by using the quantum group q(x,y), which includes the output value Out(x−1,y) of the adjacent pixel (x−1,y) and the output value Out(x,y−1) of the adjacent pixel (x,y−1), input from the quantization memory 210 and the variable threshold group To(x,y), which includes the first variable threshold value To1(x,y) and the second variable threshold value To2(x,y), input from the variable threshold setting unit 208, so as to set the threshold group T(x,y) including a first threshold value T1(x,y) and a second threshold value T2(x,y) of a position of the target pixel and output the threshold group T(x,y) to the comparison and determination unit 203.

$$If ( Out ( x - 1 , y ) = 255 ) \\ then T 1 ( x , y ) = To 1 ( x , y ) , \\ T 2 ( x , y ) = To 2 ( x , y ) \\ Else If ( Out ( x , y - 19 = 255 ) \\ then T 1 ( x , y ) = To 1 ( x , y ) , \\ T 2 ( x , y ) = To 2 ( x , y ) \\ Else \\ then T 1 ( x , y ) = To 2 ( x , y ) , \\ T 2 ( x , y ) = To 2 ( x , y ) . \qquad Equation 5$$

As described above, the multi-level error diffusion process is executed by the configuration of the image processing apparatus 2 of FIG. 7.

By performing the above-described process according to the second exemplary embodiment of the present patent specification, the following effects can be obtained.

As shown in FIG. 8, the first variable threshold value To1(x,y) may be different according to the input data In(x,y). First, when a gray scale value is 0, the first variable threshold value To1(x,y) is 64. As the input gray scale value goes up to 191, the first variable threshold value To1(x,y) increases. Even when the input gray scale value becomes 192 or greater, the first variable threshold value To1(x,y) remains to be 127, which is the same value as the second variable threshold value To2(x,y). Further, the second variable threshold value To2(x,y) remains to be a constant value, which is 127, regardless of the input value.

According to Equation 5, then both of the output values of the two pixels neighboring the target pixel are not for outputting large dots, which is same as the first exemplary embodiment, the first threshold value T1(x,y) and the second threshold value T2(x,y) are calculated to be an identical value. In this case, only dot-off holes or large dots may be output, which is same as the binary-level error diffusion, and isolated small dots may not be output.

Only when at least one output value of the two pixels neighboring the target pixel is calculated as 255, which indicates a large dot, a calculated value of the first threshold value T1(x,y) may be different from a calculated value of the second threshold value T2(x,y). When a gray scale value is 1, the first variable threshold value To1(x,y) is approximately 64. With such low value, since large dots are output in the adjacent pixels, the dots are less likely to be generated and output due to the diffusion of negative error values. However, small dots are likely to be generated and output easily, which can cause the small dots to be output adjacent to the large dots.

Further, when the gray scale value is around 191, the first variable threshold value To1(x,y) becomes approximately 126. Since the first variable threshold value To1(x,y) and the second variable threshold value To2(x,y) are so close, large dots may be output instead of small dots depending on accumulated errors. Further, when the gray scale value is 192 or greater, the first variable threshold value To1(x,y) and the second variable threshold value To2(x,y) may be made equal to each other. Therefore, similar to the binary error diffusion, only dot-off holes or large dots are output, and isolated small dots are not output.

In the first exemplary embodiment, a dot pattern in which large dots are dispersed in the low gray scale area is formed, which is similar to the binary error diffusion. By contrast, in the second exemplary embodiment, it is likely that small dots are formed adjacent to large dots even in the low gray scale area, and therefore the image reproducibility in the low gray scale area can be improved.

Further, in the high gray scale area, gradation expression is performed with large dots and dot-off holes, where small dots are not used, which is similar to the binary error diffusion, and therefore the image reproducibility can be improved. By contrast, in the first exemplary embodiment, the gradation expression is performed using mixture of large dots and small dots in the high gray scale area, and therefore a dot pattern with small dots each being surrounded by large dots may be caused.

In theory, the gradation expression with large dots and small dots is more preferable than the gradation expression with large dots and dot-off holes, from a viewpoint of image quality or texture. However, depending on electrophotographic apparatuses, the dot pattern with small dots surrounded by large dots may be developed to an image same as a dot pattern filled up with large dots. When an image is output by such printer or other image output device, it is preferable to employ the method described in the second exemplary embodiment.

Further, when the gradation expression is performed using the binary error diffusion in the high gray scale area, it is not limited to use the variable threshold value shown in the graph of FIG. 8. Instead of the variable threshold value in the graph of FIG. 8, the gradation expression can also be performed by only switching the gray scale values of the first variable threshold value To1(x,y) and the second variable threshold value To2(x,y) to be same or different in a target gray scale value. In this case, however, dot-off holes, small dots, and large dots are used when a gray scale value is set to a value smaller than the target gray scale value for switching, while dot-off holes and large dots are used when the gray scale value is set to a value greater than the target gray scale value for switching. Therefore, dot gain may become different, and thus tone jump occurs, which can result in occurrence of contour in the switched gradation when the gradation image is output.

By contrast, when the difference of values of the first variable threshold value To1(x,y) and the second variable threshold value To2(x,y) is gradually reduced as shown in the graph of FIG. 8, there may be substantially no difference immediately before the gray scale values of the first variable threshold value To1(x,y) and the second variable threshold value To2(x,y) become equal. Therefore, small dots are rarely output, and thus it is less likely to cause the tone jump occurs, that is, to cause the contour to appear.

### Third Exemplary Embodiment

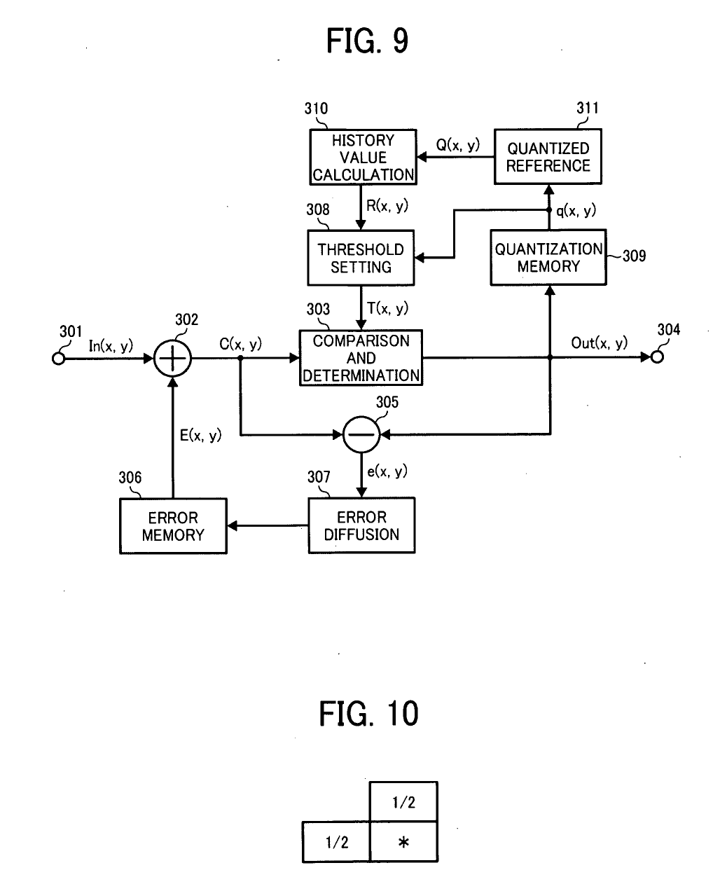

FIG. 9 shows a schematic configuration diagram of the image processing apparatus 2, according to a third exemplary embodiment.

Multi-level image data from the image input apparatus 1 is input to an input terminal 301 of the image processing apparatus 2. Hereinafter, the multi-level image data input from the image input apparatus 1 is referred to as “input data In(x,y)” to indicate that it is two-dimensional image data, where “x” represents an address of an image in a main scanning direction and “y” represents an address of the image in a sub-scanning direction

The input data In(x,y) is then input to an adder 302. The adder 302 adds an error element E(x,y) input from an error memory 306 to the input data In(x,y) to obtain correction data C(x,y), and outputs the correction data C(x,y) to a comparison and determination unit 303 and a subtractor 305.

The comparison and determination unit 303 compares and determines an output value Out(x,y) based on the correction data C (x,y) input from the adder 302 and a threshold group T (x,y) input from a threshold setting unit 308, as shown in Equation 1. The threshold group T (x,y) is a group including a first threshold value T1(x,y) and a second threshold value T2(x,y). The first threshold value T1(x,y) is a threshold value to determine whether a dot to be output is a dot-off or a small dot. The second threshold value T2(x,y) is a threshold value to determine whether a dot to be output is a small dot or a large dot. The output value Out(x,y) obtained through the above-described process is output from an output terminal 304 to the image forming apparatus 3.

The output value Out(x,y) is also input to a quantization memory 309 and the subtractor 305.

The subtractor 305 subtracts the output value Out(x,y) from the correction data C(x,y) to obtain an error e(x,y), as shown in Equation 2. Accordingly, the error e(x,y) generated in a present target pixel can be calculated.

The error e(x,y) is input to an error diffusion unit 307. The error diffusion unit 307 distributes or diffuses the error e(x,y) as shown in Equation 3, so as to add the error e(x,y) to error data E(x,y) stored in the error memory 306.

The quantization memory 309, which stores the output value Out(x,y) of the target pixel, outputs a quantum group q(x,y) that includes multiple quantized states of multiple pixels near the target pixel, which may be needed in a quantized reference unit 311, to the quantized reference unit 311 and the threshold setting unit 308. Here, the quantization memory 309 outputs output values of two pixels, shown in FIG. 10, adjacent to the target pixel (x,y) as the quantum group q(x,y). Specifically, the quantization memory 309 outputs the quantum group q(x,y) including an output value Out(x−1,y) of an adjacent pixel (x−1,y) and an output value Out(x,y−1) of an adjacent pixel (x,y−1).

The quantized reference unit 311 outputs a weighted average value Q(x,y) that is obtained by weighting and referencing by multiple quantized states of multiple pixels near the target pixel, based on based on a reference coefficient given in advance, to the quantum group q(x,y), which includes the output value Out(x−1,y) and the output value Out(x,y−1), input from the quantization memory 309.

FIG. 10 shows coefficients of a reference matrix. When the coefficients shown in FIG. 10 are used as reference coefficients, the quantized reference unit 311 executes processes of the following Equation 6. The weighted average value Q(x,y)is output to a history value calculation unit 310.

Q(x,y)=Out(x−1,y)×½+Out(x,y−1)×½ Equation 6.

The history value calculation unit 310 calculates a history value R(x,y) using the following Equation 7 with the weighted average value Q(x,y) output from the quantized reference unit 311 and a history coefficient h given in advance, and outputs the history value R(x,y) obtained through the above-described process to the threshold setting unit 308. Here, the history coefficient h is set to 0.5.

R(x,y)=h×Q(x,y) Equation 7.

The threshold setting unit 308 uses the following Equation 8 by using the quantum group q(x,y), which includes the output value Out(x−1,y) of the adjacent pixel (x−1,y) and the output value Out(x,y−1) of the adjacent pixel (x,y−1), input from the quantization memory 309 and the history value R(x,y) input from the history value calculation unit 310, so as to set the threshold group T(x,y) including the first threshold value T1(x,y) and the second threshold value T2(x,y) of a position of the target pixel and output the threshold group T(x,y) to the comparison and determination unit 303.

$$If ( Out ( x - 1 , y ) = 255 ) \\ then T 1 ( x , y ) = 64 - R ) x , y ) , \\ T 2 ( x , y ) = 127 - R ( x , y ) \\ Else If ( Out ( x , y - 1 ) = 255 ) \\ then T 1 ( x , y ) = 64 - R ( x , y ) , \\ T 2 ( x , y ) = 127 - R ( x , y ) \\ Else \\ then T 1 ( x , y ) = 127 - R ( x , y ) , \\ T 2 ( x , y ) = 127 - R ( x , y ) . \qquad Equation 8$$

As described above, the multi-level error diffusion process is executed by the configuration of the image processing apparatus 2 of FIG. 9.

By performing the above-described process according to the third exemplary embodiment of the present patent specification, the following effects can be obtained.

Different from the first exemplary embodiment, the third exemplary embodiment uses the weighted average value Q(x,y) to which the quantized states of the neighboring pixels of the target pixel are weighted and referenced in the history value calculation unit 310 so as to correct the threshold value according to the history value R(x,y). In Equation 8, when the output values Out(x−1,y) and Out(x,y−1) of the adjacent two pixels (x−1,y) and (x,y−1) residing near the target pixel are both 255, the weighted average value Q(x,y) may be 255 based on Equation 9. When the history coefficient h is 0.5, the history value R(x,y) may be 127 based on Equation 7. In Equation 8, the history value R(x,y) is subtracted from the first threshold value T1(x,y) and the second threshold value T2(x,y) used in the first exemplary embodiment. Therefore, if large and small dots are output at the pixel positions of the pixels adjacent to the target pixel, the threshold value set in the third exemplary embodiment may be smaller than the threshold value set in the first exemplary embodiment, and thus it is likely that dots can easily reside adjacent to each other even when the errors are not sufficiently accumulated. Particularly, if the dots reside adjacent to each other easily in the low gray scale area, the results can be more preferable than the results in the first exemplary embodiment. Consequently, the third exemplary embodiment can provide preferable results in an image forming apparatus in which a cluster is preferably formed with large and small dots without isolating the large dots.

In the third exemplary embodiment, the history coefficient h is set to 0.5, but the coefficient is not limited to 0.5. For example, as the history coefficient h becomes greater, the first threshold value T1(x,y) and the second threshold value T2(x,y) may become sufficiently small. Therefore, even when negative errors due to pixels adjacent to the target pixel are accumulated, small dots can be output more easily. Accordingly, the history coefficient h may be output according to stability of an output unit.

In the third exemplary embodiment, the weighted average value Q(x,y) is obtained based on the pixel position and the coefficient as shown in FIG. 10. However, but the present patent application can be applied to a case in which the number of the pixel positions to be referenced is increased according to stability of an output unit. For example, when using an output unit that can stabilize pixels residing not only in the main scanning direction and the sub-scanning direction but also residing sequentially on an upper or lower right hand side and an upper or lower left hand side, output values of pixels on the upper right hand side and the upper left hand side, such as output values Out(x+1,y−1) and Out(x−1,y−1), with respect to the target pixel can be set to be referenced.

### Fourth Exemplary Embodiment

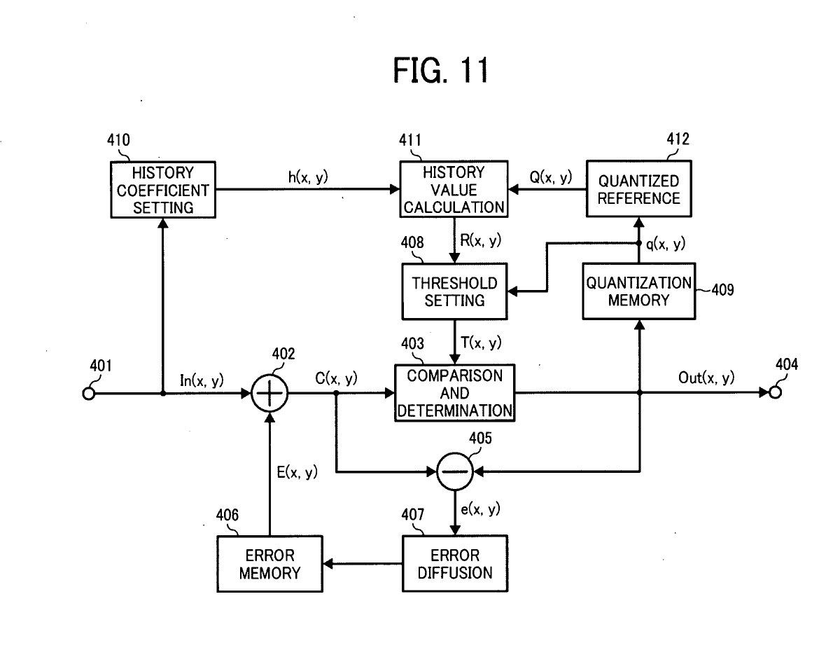

FIG. 11 shows a schematic configuration diagram of the image processing apparatus 2, according to a fourth exemplary embodiment.

Multi-level image data from the image input apparatus 1 is input to an input terminal 401 of the image processing apparatus 2. Hereinafter, the multi-level image data input from the image input apparatus 1 is referred to as “input data In(x,y)” to indicate that it is two-dimensional image data, where “x” represents an address of an image in a main scanning direction and “y” represents an address of the image in a sub-scanning direction.

The input data In(x,y) is then input to an adder 402. The adder 402 adds an error element E(x,y) input from an error memory 406 to the input data In(x,y) to obtain correction data C(x,y), and outputs the correction data C(x,y) to a comparison and determination unit 403 and a subtractor 405.

The input data In(x,y) is also input to a history coefficient setting unit 410.

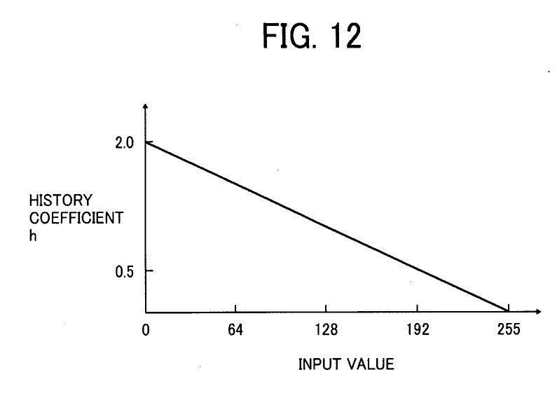

As shown in FIG. 12, the history coefficient setting unit 410 sets a history coefficient h(x,y) according to the input data In(x,y), and outputs the history coefficient h(x,y) to a history value calculation unit 411.

The comparison and determination unit 403 compares and determines the output value Out(x,y) based on the correction data C (x,y) input from the adder 402 and a threshold group T (x,y) input from a threshold setting unit 408, as shown in Equation 1. The output value Out(x,y) obtained through the above-described process is output from an output terminal 404 to the image forming apparatus 3.

The output value Out(x,y) is also input to a quantization memory 409 and the subtractor 405.

The subtractor 405 subtracts the output value Out(x,y) from the correction data C(x,y) to obtain an error e(x,y), as shown in Equation 2. Accordingly, the error e(x,y) generated in a present target pixel can be calculated.

The error e(x,y) is input to an error diffusion unit 407. The error diffusion unit 407 distributes or diffuses the error e(x,y) as shown in Equation 3 so as to add the error e(x,y) to error data E(x,y) stored in the error memory 406.

The quantization memory 409, which stores the output value Out(x,y) of the target pixel, outputs a quantum group q(x,y) that includes multiple quantized states of multiple pixels near the target pixel, which may be needed in a quantized reference unit 412, to the quantized reference unit 412 and the threshold setting unit 408.

Here, the quantization memory 409 outputs output values of two pixels adjacent to the target pixel (x,y) as the quantum group q(x,y). Specifically, the quantization memory 309 outputs the quantum group q(x,y) including an output value Out(x−1,y) of an adjacent pixel (x−1,y) and an output value Out(x,y−1) of an adjacent pixel (x,y−1), as shown in FIG. 10.

The quantized reference unit 412 outputs a weighted average value Q(x,y) that is obtained by weighting and referencing multiple quantized states of multiple pixels near the target pixel, based on based on a reference coefficient given in advance, to the quantum group q(x,y), which includes the output value Out(x−1,y) and the output value Out(x,y−1), input from the quantization memory 409.

For example, when the coefficients shown in FIG. 10 are used as reference coefficients, the quantized reference unit 412 executes processes of Equation 6. The weighted average value Q(x,y) is output to the history value calculation unit 411.

The history value calculation unit 411 calculates a history value R(x,y) using the following Equation 10 with the weighted average value Q(x,y) output from the quantized reference unit 412 and a history coefficient h(x,y) output from the history coefficient setting unit 410, and outputs the history value R(x,y) obtained through the above-described process to the threshold setting unit 408.

R(x,y)=h(x,y)×Q(x,y) Equation 9.

The threshold setting unit 408 use Equation 8 by using the quantum group q(x,y), which includes the output value Out(x−1,y) of the adjacent pixel (x−1,y) and the output value Out(x,y−1) of the adjacent pixel (x,y−1), input from the quantization memory 409 and the history value R(x,y) input from the history value calculation unit 411, so as to set the threshold group T(x,y) including a first threshold value T1(x,y) and a second threshold value T2(x,y) of a position of the target pixel and output the threshold group T(x,y) to the comparison and determination unit 403.

As described above, the multi-level error diffusion process is executed by the configuration of the image processing apparatus 2 of FIG. 11.

By performing the above-described process according to the fourth exemplary embodiment of the present patent specification, the following effects can be obtained.

The fourth exemplary embodiment is different from the third exemplary embodiment in employing the history coefficient h(x,y) according to input data In(x,y).

When the history coefficient is fixed as described in the third exemplary embodiment, dots tend to concentrate in the medium gray scale area. When the output values Out(x−1,y) and Out(x,y−1) of the pixels shown in FIG. 10 both indicate large dots, the history value may become high, and the first threshold value T1(x,y) and the second threshold value T2(x,y) of the target pixel positions may become low. However, when both the output values Out(x−1,y) and Out(x,y−1) of the pixels are large dots, negative errors are accumulated in the target pixel position.

To output large and small dots in the target pixel position, the correction value including a neighboring error element and an input value may need to be greater than the threshold value. Even when the threshold value is decreased according to the history value, if the neighboring error element is negative, the large and small dots may not be output unless the input value is great. Since the input value is small, dots may not reside excessively adjacent to each other in the low gray scale area. However, in the medium and high gray scale areas, the input value is large. Therefore, even if errors of the neighboring dots are negative, the correction value may be a certain value. When the correction value is smaller than a given threshold value due to the history value, large and small dots can be output. Thus, when the history value is fixed, a large amount of dots may reside adjacent to each other in the medium and high gray scale areas. This can obtain stability in image quality, which may, however, not be preferable as image design such as graininess and texture. In such case, the history coefficient h(x,y) can be used according to the input data In(x,y)as described in the fourth exemplary embodiment.

### Fifth Exemplary Embodiment

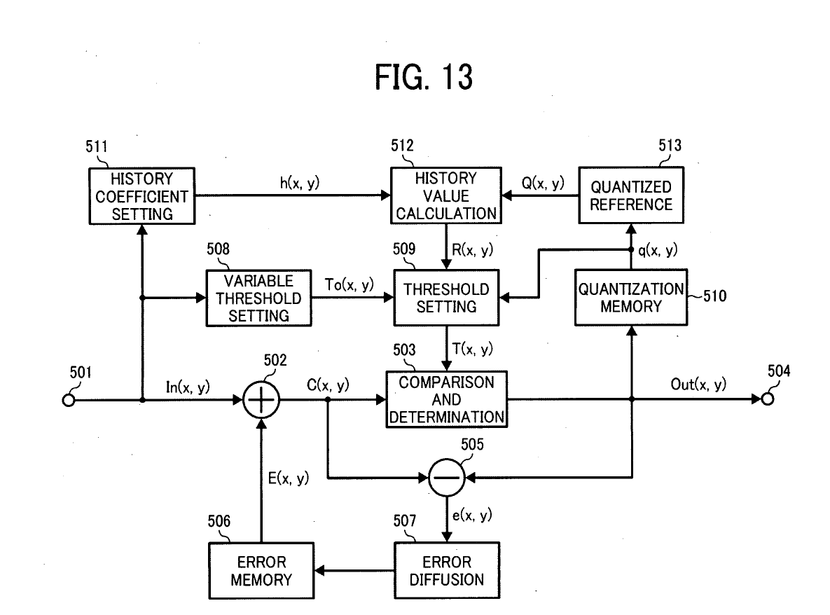

FIG. 13 shows a schematic configuration diagram of the image processing apparatus 2, according to a fifth exemplary embodiment.

Multi-level image data from the image input apparatus 1 is input to an input terminal 501 of the image processing apparatus 2. Hereinafter, the multi-level image data input from the image input apparatus 1 is referred to as “input data In(x,y)” to indicate it is two-dimensional image data, where “x” represents an address of an image in a main scanning direction and “y” represents an address of the image in a sub-scanning direction.

The input data In(x,y) is then input to an adder 502, a variable threshold setting unit 508, and a history coefficient setting unit 511.

The adder 502 adds an error element E(x,y) input from an error memory 506 to the input data In(x,y) to obtain correction data C(x,y), and outputs the correction data C(x,y) to a comparison and determination unit 503 and a subtractor 505.

The history coefficient setting unit 511 sets a history coefficient h(x,y) according to the input data In(x,y) as shown in FIG. 12, and outputs the history coefficient h(x,y) to a history value calculation unit 512.

As shown in FIG. 8, the variable threshold setting unit 508 sets a variable threshold group To(x,y) including a first variable threshold value To1(x,y) and a second variable threshold value To2(x,y) according to the input data In(x,y), and outputs the variable threshold group To(x,y) to a threshold setting unit 509.

The comparison and determination unit 503 compares and determines an output value Out(x,y) based on the correction data C (x,y) input from the adder 502 and a threshold group T (x,y) input from the threshold setting unit 509, as shown in Equation 1. The output value Out(x,y) obtained through the above-described process is output from an output terminal 504 to the image forming apparatus 3.

The output value Out(x,y) is also input to a quantization memory 510 and the subtractor 505.

The subtractor 505 subtracts the output value Out(x,y) from the correction data C(x,y) to obtain an error e(x,y), as shown in Equation 2. Accordingly, the error e(x,y) generated in a present target pixel can be calculated.

The error e(x,y) is input to an error diffusion unit 507. The error diffusion unit 507 distributes or diffuses the error e(x,y) as shown in Equation 3 so as to add the error e(x,y) to error data E(x,y) stored in the error memory 506.

The quantization memory 509, which stores the output value Out(x,y) of the target pixel, outputs a quantum group q(x,y) that includes multiple quantized states of multiple pixels near the target pixel, which may be needed in a quantized reference unit 513, to the quantized reference unit 513 and the threshold setting unit 509.

Here, the quantization memory 510 outputs output values of two pixels, shown in FIG. 10, adjacent to the target pixel (x,y) as the quantum group q(x,y). Specifically, the quantization memory 510 outputs the quantum group q(x,y) including an output value Out(x−1,y) of an adjacent pixel (x−1,y) and an output value Out(x,y−1) of an adjacent pixel (x,y−1).

The quantized reference unit 513 outputs a weighted average value Q(x,y) that is obtained by weighting and referencing multiple quantized states of multiple pixels near the target pixel, based on a reference coefficient given in advance, to the quantum group q(x,y), which includes the output value Out(x−1,y) and the output value Out(x,y−1), input from the quantization memory 510.

As previously described, FIG. 10 shows the coefficients of the reference matrix. When the coefficients shown in FIG. 10 are used as reference coefficients, the quantized reference unit 510 executes processes of Equation 6. The weighted average value Q(x,y)is output to the history value calculation unit 512.

The history value calculation unit 512 calculates a history value R(x,y) using the following Equation 9 with the weighted average value Q(x,y) output from the quantized reference unit 513 and a history coefficient h output from the quantized reference unit 513, and outputs the history value R(x,y) obtained through the above-described process to the threshold setting unit 509.

The threshold setting unit 509 use Equation 10 shown below, by using the quantum group q(x,y), which includes the output value Out(x−1,y) of the adjacent pixel (x−1,y) and the output value Out(x,y−1) of the adjacent pixel (x,y−1), input from the quantization memory 510, the history value R(x,y) input from the history value calculation unit 512, and the variable threshold group To(x,y) including the first variable threshold value To1(x,y) and the second variable threshold value To2(x,y), input from the variable threshold setting unit 508, so as to set a threshold group T(x,y) including a first threshold value T1(x,y) and a second threshold value T2(x,y) of a position of the target pixel and output the threshold group T(x,y) to the comparison and determination unit 503.

$$If ( Out ( x - 1 , y ) = 255 ) \\ then T 1 ( x , y ) = To 1 ( x , y ) - R ( x , y ) , \\ T 2 ( x , y ) = To 2 ( x , y ) - R ( x , y ) \\ Else If ( Out ( x , y - 1 ) = 255 ) \\ then T 1 ( x , y ) = To 1 ( x , y ) - R ( x , y ) , \\ T 2 ( x , y ) = To 2 ( x , y ) - R ( x , y ) \\ Else \\ then T 1 ( x , y ) = To 2 ( x , y ) - R ( x , y ) , \\ T 2 ( x , y ) = To 2 ( x , y ) - R ( x , y ) . \qquad Equation 10$$

As described above, the multi-level error diffusion process in the image processing apparatus 2 is executed with the configuration of FIG. 13.

By performing the above-described process according to the fifth exemplary embodiment of the present patent specification, the following effects can be obtained.

The fifth exemplary embodiment is a combination of the second and fourth exemplary embodiments. In the fourth exemplary embodiment, which is similar to the first exemplary embodiment, the gradation expression is performed using a mixture of large dots and small dots in the high gray scale area, and therefore a dot pattern with small dots each being surrounded by large dots may be caused. However, depending on electrophotographic apparatuses, the dot pattern with small dots surrounded by large dots may be developed to an image same as a dot pattern filled up with large dots. Therefore, as described in the second exemplary embodiment and the fifth exemplary embodiment, it is better to use the first variable threshold value To1(x,y) and the second variable threshold value To2(x,y) according to the input data In(x,y).

### Sixth Exemplary Embodiment

Next, a description is given of a schematic configuration diagram of the image processing apparatus 2, according to a sixth exemplary embodiment. Since the configuration according to the sixth exemplary embodiment is substantially same as the configuration according to the first exemplary embodiment, except that the configuration of the sixth exemplary embodiment includes an error diffusion unit 607 instead of the error diffusion unit 107 in the first exemplary embodiment. Therefore, FIG. 5 is used to describe the configuration of the sixth exemplary embodiment.

Multi-level image data from the image input apparatus 1 is input to the input terminal 101 of the image processing apparatus 2. Hereinafter, the multi-level image data input from the image input apparatus 1 is referred to as “input data In(x,y)” to indicate that it is two-dimensional image data, where “x” represents an address of an image in a main scanning direction and “y” represents an address of the image in a sub-scanning direction.

The input data In(x,y) is then input to the adder 102. The adder 102 adds an error element E(x,y) input from the error memory 106 to the input data In(x,y) to obtain correction data C(x,y), and outputs the correction data C(x,y) to the comparison and determination unit 103 and the subtractor 105.

The comparison and determination unit 103 compares and determines an output value Out(x,y) based on the correction data C (x,y) input from the adder 102 and a threshold group T (x,y) input from the threshold setting unit 108, as Equation 1 described in the first exemplary embodiment. The threshold group T (x,y) is a group including a first threshold value T1(x,y) and a second threshold value T2(x,y). The first threshold value T1(x,y) is a threshold value to determine whether a dot to be output is a dot-off or a small dot. The second threshold value T2(x,y) is a threshold value to determine whether a dot to be output is a small dot or a large dot.

The output value Out(x,y) obtained through the above-described process is output from the output terminal 104 to the image forming apparatus 3.

The output value Out(x,y) is also input to the quantization memory 109 and the subtracter 105.

The subtracter 105 subtracts the output value Out(x,y) from the correction data C(x,y) to obtain an error e(x,y), as Equation 2 described in the first exemplary embodiment. Accordingly, the error e(x,y) generated in a present target pixel can be calculated.

The error e(x,y) is input to an error diffusion unit 607. The error diffusion unit 607 distributes or diffuses the error e(x,y) based on a diffusion coefficient given in advance so as to add the error e(x,y) to error data E(x,y) stored in the error memory 106.

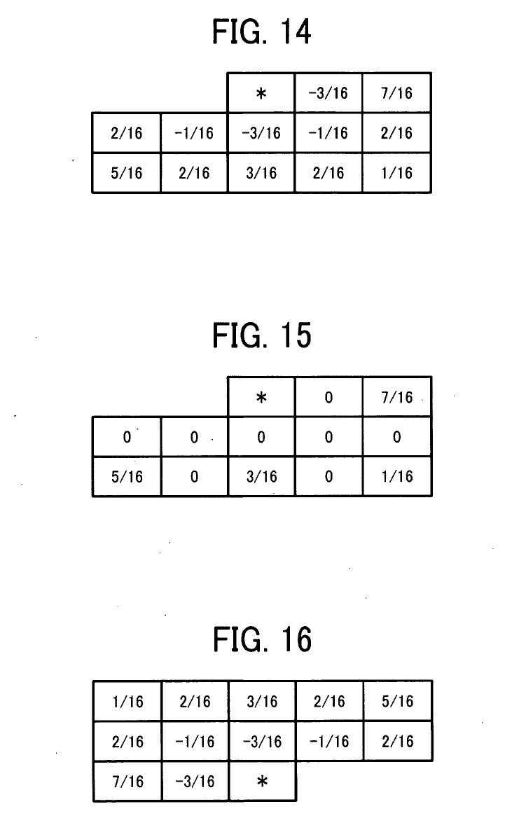

For example, FIGS. 14 through 16 show coefficients of an error matrix.

When the coefficients shown in FIG. 14 are used as diffusion coefficients, the error diffusion unit 607 executes processes of the following Equation 11.

E(x+1,y)=E(x+1,y)+e(x,y)×(−3)/16

E(x+2,y)=E(x+2,y)+e(x,y)× 7/16

E(x−2,y+1)=E(x−2,y+1)+e(x,y)× 2/16

E(x−1,y+1)=E(x−1,y+1)+e(x,y)×(−1)/16

E(x,y+1)=E(x,y+1)+e(x,y)×(−3)/16

E(x+1,y+1)=E(x+1,y+1)+e(x,y)×(−1)/16

E(x+2,y+1)=E(x+2,y+1)+e(x,y)× 2/16

E(x−2,y+1)=E(x−2,y+2)+e(x,y)× 5/16

E(x−1,y+2)=E(x−1,y+2)+e(x,y)× 2/16

E(x,y+2)=E(x,y+2)+e(x,y)× 3/16

E(x+1,y+2)=E(x+1,y+2)+e(x,y)× 2/16

E(x+2,y+2)=E(x+2,y+2)+e(x,y)× 1/16 Equation 11.

The quantization memory 109, which stores the output value Out(x,y) of the target pixel, outputs a quantum group q(x,y) that includes multiple quantized states of multiple pixels near the target pixel to the threshold setting unit 108. Here, the quantization memory 109 outputs output values of two pixels adjacent to the target pixel (x,y) as the quantum group q(x,y). Specifically, the quantization memory 109 outputs the quantum group q(x,y) including an output value Out(x−1,y) of an adjacent pixel (x−1,y) and an output value Out(x,y−1) of an adjacent pixel (x,y−1).

The threshold setting unit 108 use Equation 4 described in the first exemplary embodiment by using the quantum group q(x,y), which includes the output value Out(x−1,y) of the adjacent pixel (x−1,y) and the output value Out(x,y−1) of the adjacent pixel (x,y−1), input from the quantization memory 109, so as to set the threshold group T(x,y) including the first threshold value T1(x,y) and the second threshold value T2(x,y) of a position of the target pixel and output the threshold group T(x,y) to the comparison and determination unit 103.

As described above, the multi-level error diffusion process is executed by the configuration of the image processing apparatus 2 of FIG. 5.

By performing the above-described process according to the sixth exemplary embodiment, the following effects can be obtained.

As shown in Equation 4, the first threshold value T1(x,y) may be either 64 or 127 depending on the output values Out(x−1,y) and Out(x,y−1) of the adjacent pixels (x−1,y) and (x,y−1) residing near the target pixel.

When both of the output values of the two pixels neighboring the target pixel are not for outputting large dots, the first threshold value T1(x,y) and the second threshold value T2(x,y) are calculated as 127. In this case, only dot-off holes or large dots may be output, which is same as a binary-level error diffusion, and isolated small dots may not be output.

Only when at least one output value of the two pixels neighboring the target pixel is calculated as 255, which indicates a large dot, a calculated value of the first threshold value T1(x,y) may be different from a calculated value of the second threshold value T2(x,y).

In general, when dots are output, the error diffusion diffuses quantization errors to neighboring pixels of a target pixel so as to disperse the dots according to the gray scale level of the dots. For example, if coefficients shown in FIG. 6 are used as diffusion coefficients, when large dots are output to a target pixel position in the highlighted area, the error e(x,y) occurred at the target pixel position may be negative so that the negative errors are diffused to the neighboring pixels. Therefore, it is not likely that dots are generated easily in the neighboring pixels.

By contrast, if coefficients where the coefficients adjacent to the target pixel are negative shown in FIG. 14 are used as diffusion coefficients for error diffusion, when large dots are output to a target pixel position, the error e(x,y) occurred at the target pixel position may be negative. Since the coefficients of the pixels in proximity to the target pixel are also negative, the positive errors, which are the product of negative errors and negative errors, are diffused in the proximity to the target pixel, and the negative errors are diffused to the neighboring pixels. Since the negative errors are not diffused close to the target pixel, small dots and large dots can easily be output adjacent to each other, and clusters can be formed more easily. Further, since the clusters are surely located adjacent to large dots, the output image quality can be more stable than when isolated large dots are output in the highlighted area.

By changing the number of dots adjacent to each other, that is, changing the cluster size, stability in image quality according to an output unit can be obtained. With the coefficients in FIG. 14, by increasing a level of negative errors of the coefficients of pixels in the proximity to the target pixel or by increasing the number of pixels having negative coefficients in the proximity to the target pixel, the cluster size can be increased.

In a general program and circuit design, multiplication of negative coefficients is not preferable in execution speed. Instead of not using negative coefficients as in a matrix shown in FIG. 14, the coefficients of the pixels neighboring the target pixel position can be set to 0, as in a matrix shown in FIG. 15.

If the errors are diffused with the coefficients shown in FIG. 15, when large dots are output at the target pixel position, the error e(x,y) occurred at the target pixel position may be negative. However, since the coefficients of the neighboring pixels of the target pixel are 0, the negative errors may not be diffused to the neighboring pixels. Therefore, small dots and large dots are likely to be output and located adjacent to each other, so that a cluster can easily be formed.

The error diffusion technique is used in the sixth exemplary embodiment. However, the technique that can be used in the sixth exemplary embodiment is not limited thereto. For example, the minimized average error method can be applied to the sixth exemplary embodiment. The difference between the error diffusion technique and the minimized average error method is in the timing of performing the error diffusion process, that is, the minimized average error method can be performed by switching the error memory 106 and the error diffusion unit 107 in the configuration shown in FIG. 5. Therefore, when the minimized average error method is employed, the coefficients of FIG. 14 may be arranged symmetrical with respect to the target pixel as shown in FIG. 16.

In the sixth exemplary embodiment, the threshold setting unit 108 employs the output values Out(x−1,y) and Out(x,y−1) of the adjacent pixels residing adjacent to the target pixel. However, the setting of the threshold setting unit 108 can be changed according to stability of an output unit. For example, when using an output unit that can stabilize pixels residing not only in the main scanning direction and the sub-scanning direction but also residing sequentially on an upper or lower right hand side and an upper or lower left hand side, output values pixels on the upper right hand side and the upper left hand side, such as output values Out(x+1,y−1) and Out(x−1,y−1), with respect to the target pixel can be set to be referenced.

The sixth exemplary embodiment has been explained for a tertiary-level error diffusion. However, the present patent specification can be applied for a quaternary-level error diffusion. The quaternary-level error diffusion uses three threshold values: a first threshold value T1(x,y) is a threshold value to determine whether dot-off holes or small dots are output; a second threshold value T2(x,y) is a threshold value to determine whether small dots or medium dots are output; and a third threshold value T3(x,y) is a threshold value to determine whether medium dots or large dots are output. For the quaternary-level error diffusion, Equation 4 can be modified to the following Equation 4′ that is described in the first exemplary embodiment. That is, when large dots are not output in any pixel of the output values of the neighboring pixels of the target pixel, the first threshold value T1(x,y), the second threshold value T2 (x,y), and the third threshold value T3(x,y) may be made equal so as to convert to the binary error diffusion. By contrast, when large dots are output in one or more pixels of the output values of the neighboring pixels of the target pixel, the first threshold value T1(x,y), the second threshold value T2 (x,y), and the third threshold value T3(x,y) may be made different from each other.

As described above, by referencing the quantized states of the neighboring pixels of the target pixel to set a threshold value, dots smaller than the large dots (i.e., smaller dots and medium dots) can be output adjacent to the large dots. Accordingly, texture may be improved in the medium and high gray scale areas and images having good reproducibility can be obtained.

As previously described, while the error diffusion technique is used in the sixth exemplary embodiment, the minimized average error method is also applicable to the sixth exemplary embodiment.

### Seventh Exemplary Embodiment

Next, a description is given of a schematic configuration diagram of the image processing apparatus 2, according to a seventh exemplary embodiment. Since the configuration according to the seventh exemplary embodiment is substantially same as the configuration according to the second exemplary embodiment, except that the configuration of the seventh exemplary embodiment includes an error diffusion unit 707 instead of the error diffusion unit 207 in the second exemplary embodiment. Therefore, FIG. 7 is used to describe the configuration of the seventh exemplary embodiment.

Multi-level image data from the image input apparatus 1 is input to the input terminal 201 of the image processing apparatus 2. Hereinafter, the multi-level image data input from the image input apparatus 1 is referred to as “input data In(x,y)” to indicate that it is two-dimensional image data, where “x” represents an address of an image in a main scanning direction and “y” represents an address of the image in a sub-scanning direction.

The input data In(x,y) is then input to the adder 202 and the variable threshold setting unit 208. The adder 202 adds an error element E(x,y) input from the error memory 206 to the input data In(x,y) to obtain correction data C(x,y), and outputs the correction data C(x,y) to the comparison and determination unit 203 and the subtractor 205.

The variable threshold setting unit 208 sets a variable threshold group To(x,y) including a first variable threshold value To1(x,y) and a second variable threshold value To2(x,y) according to the input data In(x,y) as shown in FIG. 8, and outputs the variable threshold group To(x,y) to the threshold setting unit 209.

The comparison and determination unit 203 compares and determines an output value Out(x,y) based on the correction data C (x,y) input from the adder 202 and a threshold group T (x,y) input from the threshold setting unit 209, as shown in Equation 1. The output value Out(x,y) obtained through the above-described process is output from the output terminal 204 to the image forming apparatus 3.

The output value Out(x,y) is also input to the quantization memory 210 and the subtractor 205.

The subtractor 205 subtracts the output value Out(x,y) from the correction data C(x,y) to obtain an error e(x,y), as shown in Equation 2. Accordingly, the error e(x,y) generated in a present target pixel can be calculated.

The error e(x,y) is input to an error diffusion unit 707. The error diffusion unit 707 distributes or diffuses the error e(x,y) as shown in Equation 11 so as to add the error e(x,y) to error data E(x,y) stored in the error memory 206.

The quantization memory 210, which stores the output value Out(x,y) of the target pixel, outputs a quantum group q(x,y) that includes multiple quantized states of multiple pixels near the target pixel to the threshold setting unit 209. Here, the quantization memory 210 outputs output values of two pixels adjacent to the target pixel (x,y) as the quantum group q(x,y). Specifically, the quantization memory 210 outputs the quantum group q(x,y) including an output value Out(x−1,y) of an adjacent pixel (x−1,y) and an output value Out(x,y−1) of an adjacent pixel (x,y−1).

The threshold setting unit 209 use Equation 5 described in the second exemplary embodiment by using the quantum group q(x,y), which includes the output value Out(x−1,y) of the adjacent pixel (x−1,y) and the output value Out(x,y−1) of the adjacent pixel (x,y−1), input from the quantization memory 210 and the variable threshold group To(x,y), which includes the first variable threshold value To1(x,y) and the second variable threshold value To2(x,y), input from the variable threshold setting unit 208, so as to set a threshold group T(x,y) including a first threshold value T1(x,y) and a second threshold value T2(x,y) of a position of the target pixel and output the threshold group T(x,y) to the comparison and determination unit 203.

As described above, the multi-level error diffusion process is executed by the configuration of the image processing apparatus 2 of FIG. 7.

By performing the above-described process according to the seventh exemplary embodiment of the present patent specification, the following effects can be obtained.

As shown in FIG. 8, the first variable threshold value To1(x,y) may be different according to the input data In(x,y). First, when a gray scale value is 0, the first variable threshold value To1(x,y) is 64. As the input gray scale value goes up to 191, the first variable threshold value To1(x,y) increases. Even when the input gray scale value becomes 192 or greater, the first variable threshold value To1(x,y) remains to be 127, which is the same value as the second variable threshold value To2(x, y). Further, the second variable threshold value To2(x,y) remains to be a constant value, which is 127, regardless of the input value.

According to Equation 5, then both of the output values of the two pixels neighboring the target pixel are not a large dot, which is same as the sixth exemplary embodiment, the first threshold value T1(x,y) and the second threshold value T2(x,y) are calculated to be an identical value. In this case, only dot-off holes or large dots may be output, which is same as the binary-level error diffusion, and isolated small dots may not be output.

Further, as shown in Equation 11, if the errors are diffused with the coefficients of the neighboring pixels of the target pixel, which are negative, when large dots are output to the target pixel position, the error e(x,y) occurred in the target pixel position may become negative. Since the coefficients of the neighboring pixels of the target pixel are also negative, the positive errors, which are the product of negative errors and negative errors, are diffused in the proximity to the target pixel. Therefore, small dots or large dots can easily be output, and clusters can be formed more easily. Further, since the clusters are surely located adjacent to the large dots, the output image quality can be more stable than when isolated large dots are output in the highlighted area.

Further, when the gray scale value is around 191, the first variable threshold value To1(x,y) becomes approximately 126. Since the first variable threshold value To1(x,y) and the second variable threshold value To2(x,y) are so close, large dots may be output instead of small dots depending on accumulated errors. Further, when the gray scale value is 192 or greater, the first variable threshold value To1(x,y) and the second variable threshold value To2(x,y) may be made equal to each other. Therefore, similar to the binary error diffusion, only dot-off holes or large dots are output, and isolated small dots are not output.

In the sixth exemplary embodiment, a dot pattern in which large dots are dispersed in the low gray scale area is formed, which is similar to the binary error diffusion. By contrast, in the seventh exemplary embodiment, it is likely that small dots are formed adjacent to large dots even in the low gray scale area, and therefore the image reproducibility in the low gray scale area can be improved.

Further, in the high gray scale area, gradation expression is performed with large dots and dot-off holes, where small dots are not used, which is similar to the binary error diffusion, and therefore the image reproducibility can be improved. By contrast, in the sixth exemplary embodiment, the gradation expression is performed using a mixture of large dots and small dots in the high gray scale area, and therefore a dot pattern with small dots each being surrounded by large dots may be caused.

In theory, the gradation expression with large dots and small dots is more preferable than the gradation expression with large dots and dot-off holes, from a viewpoint of image quality or texture. However, depending on electrophotographic apparatuses, the dot pattern with small dots surrounded by large dots may be developed to an image same as a dot pattern filled up with large dots. When an image is output by such printer or other image output device, it is preferable to employ the method described in the seventh exemplary embodiment.

Further, when the gradation expression is performed using the binary error diffusion in the high gray scale area, it is not limited to use the variable threshold value shown in the graph of FIG. 8. Instead of the variable threshold value in the graph of FIG. 8, the gradation expression can also be performed by only switching the gray scale values of the first variable threshold value To1(x,y) and the second variable threshold value To2(x,y) to be same or different in a target gray scale value. In this case, however, dot-off holes, small dots, and large dots are used when a gray scale value is set to a value smaller than the target gray scale value for switching, while dot-off holes and large dots are used when the gray scale value is set to a value greater than the target gray scale value for switching. Therefore, dot gain may become different, and thus tone jump occurs, which can result in occurrence of contour in the switched gradation when the gradation image is output.

By contrast, when the difference of values of the first variable threshold value To1(x,y) and the second variable threshold value To2(x,y) is gradually reduced as shown in the graph of FIG. 8, there may be substantially no difference immediately before the gray scale values of the first variable threshold value To1(x,y) and the second variable threshold value To2(x,y) become equal. Therefore, small dots are rarely output, and thus it is less likely to cause the tone jump occurs, that is, to cause the contour to appear.

The error diffusion technique is used in the seventh exemplary embodiment. However, the technique that can be used in the seventh exemplary embodiment is not limited thereto. For example, the minimized average error method can be applied to the seventh exemplary embodiment.

### Eighth Exemplary Embodiment

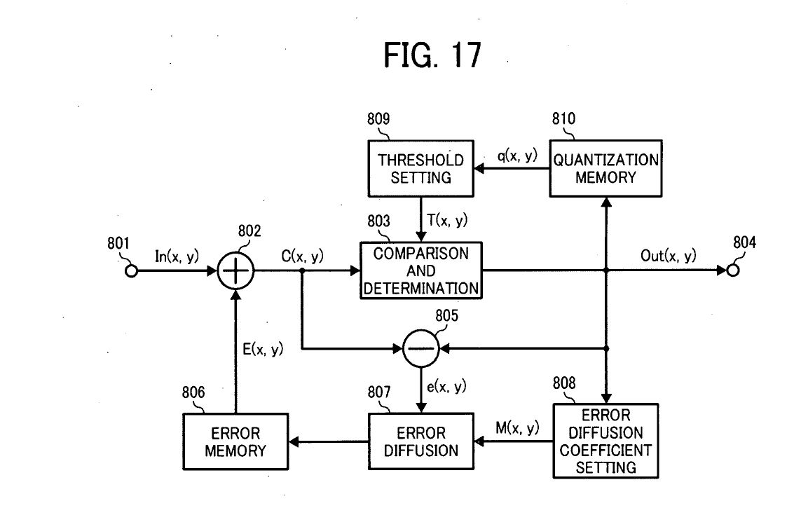

FIG. 17 shows a schematic configuration diagram of the image processing apparatus 2, according to an eight exemplary embodiment.

Multi-level image data from the image input apparatus 1 is input to an input terminal 801 of the image processing apparatus 2. Hereinafter, the multi-level image data input from the image input apparatus 1 is referred to as “input data In(x,y)” to indicate that it is two-dimensional image data, where “x” represents an address of an image in a main scanning direction and “y” represents an address of the image in a sub-scanning direction.

The input data In(x,y) is then input to an adder 802. The adder 802 adds an error element E(x,y) input from an error memory 806 to the input data In(x,y) to obtain correction data C(x,y), and outputs the correction data C(x,y) to a comparison and determination unit 803 and a subtractor 805.

The comparison and determination unit 803 compares and determines an output value Out(x,y) based on the correction data C (x,y) input from the adder 802 and a threshold group T (x,y) input from a threshold setting unit 809, as shown in Equation 1. The threshold group T (x,y) is a group including a first threshold value T1(x,y) and a second threshold value T2(x, y). The first threshold value T1(x, y) is a threshold value to determine whether a dot to be output is a dot-off hole or a small dot. The second threshold value T2(x,y) is a threshold value to determine whether a dot to be output is a small dot or a large dot.

The output value Out(x,y) obtained through the above-described process is output from an output terminal 804 to the image forming apparatus 3.

The output value Out(x,y) is also input to a quantization memory 810, an error diffusion coefficient setting unit 808, and the subtractor 805.

The subtractor 805 subtracts the output value Out(x,y) from the correction data C(x,y) to obtain an error e(x,y), as shown in the following Equation 2. Accordingly, the error e(x,y) generated in a present target pixel can be calculated.

The error diffusion coefficient setting unit 808 uses the following Equation 12 by using the output value Out(x,y) input from the comparison and determination unit 803 so as to set a diffusion coefficient matrix M(x,y) and output the diffusion coefficient matrix M(x,y) to an error diffusion unit 807. Here, “M1” indicates a diffusion coefficient matrix shown in FIG. 14 and “M2” indicates a diffusion coefficient matrix shown in FIG. 6.

$$If ( Out ( x , y ) = 255 ) \\ then M ( x , y ) = M 1 \\ Else \\ then M ( x , y ) = M 2. \qquad Equation 12$$

The error diffusion unit 807 distributes or diffuses the error e(x,y) based on the diffusion coefficient matrix M(x,y) input from the error diffusion coefficient setting unit 808, so as to add the error e(x,y) to error data E(x,y) stored in the error memory 806. When the diffusion coefficient matrix M(x,y) is M1, the error e(x,y) is processed through Equation 11. When the diffusion coefficient matrix M(x,y) is M2, the error e(x,y) is processed through Equation 3.

The quantization memory 810, which stores the output value Out(x,y) of the target pixel, outputs a quantum group q(x,y) that includes multiple quantized states of multiple pixels near the target pixel to the threshold setting unit 809. Here, the quantization memory 810 outputs output values of two pixels adjacent to the target pixel (x,y) as the quantum group q(x,y). Specifically, the quantization memory 810 outputs the quantum group q(x,y) including an output value Out(x−1,y) of an adjacent pixel (x−1,y) and an output value Out(x,y−1) of an adjacent pixel (x,y−1).

The threshold setting unit 809 use Equation 4 by using the quantum group q(x,y), which includes the output value Out(x−1,y) of the adjacent pixel (x−1,y) and the output value Out(x,y−1) of the adjacent pixel (x,y−1), input from the quantization memory 810, so as to set a threshold group T(x,y) including a first threshold value T1(x,y) and a second threshold value T2(x,y) of a position of the target pixel and output the threshold group T(x,y) to a comparison and determination unit 803.

As described above, the multi level error diffusion process in the image processing apparatus 2 is performed with the configuration shown in FIG. 17 thereof, and the following effects can be obtained.

Different from the sixth exemplary embodiment, in the eighth exemplary embodiment, the error diffusion coefficient setting unit 808 sets the diffusion coefficient matrix according to the quantized state of the target pixel position.

The cluster may easily be formed by using the diffusion coefficient matrix shown in FIG. 14. However, the position for forming the cluster may be located adjacent to the pixel to which a large dot is output. It is preferable that the cluster is dispersed according to the input value. However, the diffusion coefficient matrix shown in FIG. 14 is a diffusion coefficient matrix used for easily forming a cluster and not for easily dispersing a cluster.

By contrast, the diffusion coefficient matrix shown in FIG. 6 is used for a normal error diffusion in which coefficient of pixels close to the target pixel position are large to positive error and other coefficients gradually become smaller. Such diffusion coefficient matrix is designed to disperse dots. According to the results of Equation 12, the normal diffusion coefficient matrix can be used when large dots are not output, and the diffusion coefficient matrix for easily forming the cluster can be used when large dots are output. By switchably using these diffusion coefficient matrixes, the dispersibility of the cluster can be enhanced.

Different from the sixth and seventh exemplary embodiments, only the error diffusion technique can be used in the eight exemplary embodiment. The error diffusion technique can weight and diffuse errors to the neighboring pixels that have not been quantized with the error occurred at the target pixel position. Therefore, if the sum of the coefficients in the diffusion coefficient matrix is 1, the error diffusion technique stores the image density when any diffusion coefficient matrix is switched as needed.

By contrast, the minimized average error method weights and references quantization errors from pixels those have already been quantized and locate around the target pixel. In this case, if a weighted and referenced matrix that corresponds to the diffusion coefficient matrix is randomly switched in a pixel unit, the sum of errors to be referenced may exceed or fall below 1 depending on a pixel, and therefore the minimized average error method cannot ensure to store the density of an overall image.

Thus, it is preferable to use the configuration that employs the error diffusion technique to perform the eighth exemplary embodiment, and by so doing, the eighth exemplary embodiment can achieve better dispersibility of clusters and more stable image than the sixth and seventh exemplary embodiment.

### Ninth Exemplary Embodiment

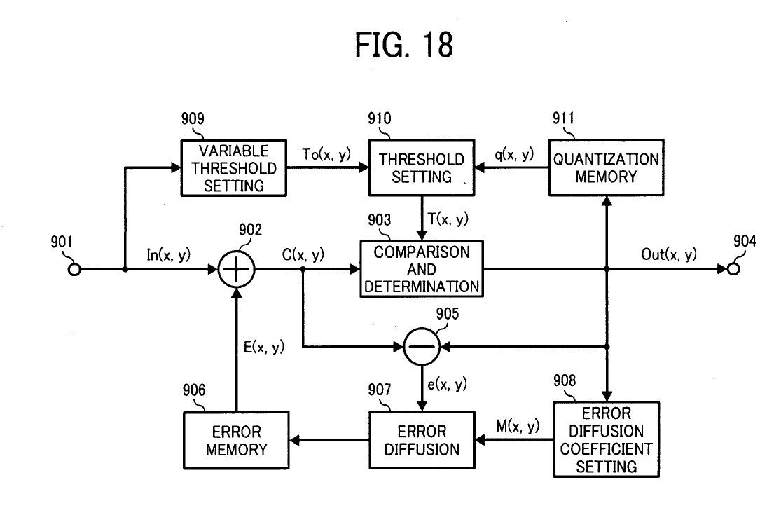

FIG. 18 shows a schematic configuration diagram of the image processing apparatus 2, according to a ninth exemplary embodiment of the present patent specification.

Multi-level image data from the image input apparatus 1 is input to an input terminal 901 of the image processing apparatus 2. Hereinafter, the multi-level image data input from the image input apparatus 1 is referred to as “input data In(x,y)” to indicate that it is two-dimensional image data, where “x” represents an address of an image in a main scanning direction and “y” represents an address of the image in a sub-scanning direction.

The input data In(x,y) is then input to an adder 902 and a variable threshold setting unit 909.

The adder 902 adds an error element E(x,y) input from an error memory 906 to the input data In(x,y) to obtain correction data C(x,y), and outputs the correction data C(x,y) to a comparison and determination unit 903 and a subtracter 905.

The variable threshold setting unit 709 sets a variable threshold group To(x,y) including a first variable threshold value To1(x,y) and a second variable threshold value To2(x,y) according to the input data In(x,y) as shown in FIG. 8, and outputs the variable threshold group To(x,y) to a threshold setting unit 910.

The comparison and determination unit 903 compares and determines an output value Out(x,y) based on the correction data C (x,y) input from the adder 902 and a threshold group T (x,y) input from the threshold setting unit 910, as shown in Equation 1 described in the first exemplary embodiment. The output value Out(x,y) obtained through the above-described process is output from an output terminal 904 to the image forming apparatus 3.

The output value Out(x,y) is also input to a quantization memory 911, a subtractor 905, and an error diffusion coefficient setting unit 908.

The subtractor 905 subtracts the output value Out(x,y) from the correction data C(x,y) to obtain an error e(x,y), as shown in Equation 2 described in the first exemplary embodiment. Accordingly, the error e(x,y) generated in a present target pixel can be calculated.

The error diffusion coefficient setting unit 708 uses Equation 12, which is described in the eight exemplary embodiment, by using the output value Out(x,y) input from the comparison and determination unit 903, so as to set a diffusion coefficient matrix M(x,y) and output the diffusion coefficient matrix M(x,y) to an error diffusion unit 907. Here, “M1” indicates a diffusion coefficient matrix shown in FIG. 14 and “M2” indicates a diffusion coefficient matrix shown in FIG. 6.

The error diffusion unit 907 distributes or diffuses the error e(x,y) based on the diffusion coefficient matrix M(x,y) input from the error diffusion coefficient setting unit 908, so as to add the error e(x,y) to the error data E(x,y) stored in the error memory 906. When the diffusion coefficient matrix M(x,y) is M1, the error e(x,y) is processed through Equation 11. When the diffusion coefficient matrix M(x,y) is M2, the error e(x,y) is processed through Equation 3.

The quantization memory 911, which stores the output value Out(x,y) of the target pixel, outputs a quantum group q(x,y) that includes multiple quantized states of multiple pixels near the target pixel to the threshold setting unit 910. Here, the quantization memory 911 outputs output values of two pixels adjacent to the target pixel (x,y) as the quantum group q(x,y). Specifically, the quantization memory 911 outputs the quantum group q(x,y) including an output value Out(x−1,y) of an adjacent pixel (x−1,y) and an output value Out(x,y−1) of an adjacent pixel (x,y−1).

The threshold setting unit 910 use Equation 5 by using the quantum group q(x,y), which includes the output value Out(x−1,y) of the adjacent pixel (x−1,y) and the output value Out(x,y−1) of the adjacent pixel (x,y−1), input from the quantization memory 911 and the variable threshold group To(x,y), which includes the first variable threshold value To1(x,y) and the second variable threshold value To2(x,y), input from the variable threshold setting unit 909, so as to set the threshold group T(x,y) including the first threshold value T1(x,y) and the second threshold value T2(x,y) of a position of the target pixel and output the threshold group T(x,y) to the comparison and determination unit 903.

As described above, the multi-level error diffusion process is executed by the configuration of the image processing apparatus 2 of FIG. 18.

A principle behind enhancement of the image processing apparatus 2 using the process in the ninth exemplary embodiment described above is explained.

Similar to the seventh exemplary embodiment, a threshold value is set in the ninth exemplary embodiment. With the threshold setting, gradation expression is performed with large dots and dot-off holes in the high gray scale area, where small dots are not used, which is similar to the binary error diffusion, and therefore the image reproducibility can be improved.

Further, similar to the eighth exemplary embodiment, the ninth exemplary embodiment sets a diffusion coefficient matrix according to the quantized state of the target pixel position. By so doing, dispersibility of the cluster can be enhanced.

Further, similar to the eighth exemplary embodiment, the ninth exemplary embodiment is preferable to use the error diffusion technique.

The exemplary embodiments mentioned earlier are described to use for the error diffusion process. However, an object of the present patent specification can also be achieved by employing the minimized average error method.

Further, an object of the present patent specification can also be achieved by providing in a system or a device, a recording medium that includes a recorded program code of software that realizes functions explained in the exemplary embodiments that are mentioned earlier, and by causing a computer (a central processing unit (CPU) or a micro processing unit (MPU)) of the system or the device to read and execute the program code that is stored in the storage medium. The program code itself, which is read from the recording medium, realizes the functions explained in the embodiments that are mentioned earlier.

A flexible disk, a hard disk, an optical disk, a magneto optical (MO) disk, a magnetic tape, a nonvolatile memory card, a read only memory (ROM), etc. can be used as the recording medium for providing the program code.

By executing the program code that is read by the computer, apart from realizing the functions explained in the exemplary embodiments that are mentioned earlier based on instructions of the program code, an operating system (OS) that is operating on the computer executes actual processes entirely or in part and the functions that are explained in the exemplary embodiments mentioned earlier are also realized by the processes.

Further, the program code, which is read from the recording medium, is written to a memory that is included in a function expansion port that is inserted into the computer or a memory that is included in a function expanding unit that is connected to the computer. Next, based on the instructions of the program code, the CPU, which is included in the function expansion port or the function expanding unit, executes the actual processes entirely or in part and the functions that are explained in the exemplary embodiments mentioned earlier are also realized by the processes.

The exemplary embodiments of the present patent specification are explained. However, the present patent specification in its broader aspects is not limited to the specific details and representative embodiments shown and described herein. Accordingly, various modifications may be made without departing from the spirit or scope of the general inventive concept as defined by the appended claims and their equivalents.

The above-described exemplary embodiments are illustrative, and numerous additional modifications and variations are possible in light of the above teachings. For example, elements and/or features of different illustrative and exemplary embodiments herein may be combined with each other and/or substituted for each other within the scope of this disclosure and appended claims. It is therefore to be understood that within the scope of the appended claims, the disclosure of the present patent specification may be practiced otherwise than as specifically described herein.

Obviously, numerous modifications and variations of the present patent specification are possible in light of the above teachings. It is therefore to be understood that within the scope of the appended claims, the present patent specification may be practiced otherwise than as specifically described herein.

This application claims priority from Japanese patent applications No. 2007-239579 filed on Sep. 14, 2007 in the Japan Patent Office, and No. 2007-305009 filed on Nov. 26, 2007 in the Japan Patent Office, the entire contents of which is hereby incorporated by reference herein.

What is claimed is:

1. An image processing apparatus configured to quantize multi-level image data of M gray levels into N-level image data (M>N>2) by using one of a multi-level error diffusion method and a multi-level minimized average error method to form an image by using a dot corresponding to each pixel included in the N-level image data,
the image processing apparatus comprising:
an adder configured to add the sum of products of weighted error values of neighboring pixels already quantized to multi-level image data of a target pixel to output a correction value;
a quantization memory configured to store quantized states of the neighboring pixels of the target pixel;
a threshold setting unit configured to set a threshold value according to the quantized states stored in the quantization memory;
a comparison and determination unit configured to compare the threshold value with the correction value and determine the N-level image data;
a subtractor configured to obtain an error generated with the N-level image data;
an error diffusion unit configured to weight and diffuse the error to the neighboring pixels of the target pixel; and
an error memory configured to store the weighted and diffused error.

2. The image processing apparatus according to claim 1, further comprising a variable threshold setting unit configured to set a variable threshold value according to the multi-level image data of the target pixel,
the threshold setting unit setting the threshold value according to the quantized states and the variable threshold value.

3. The image processing apparatus according to claim 2, wherein the variable threshold value obtained according to the multi-level image data of the target pixel includes N-1 threshold values,
the N-1 threshold values being different in low and medium gray scale area, gradually becoming closer to each other as the gray scale becomes higher, and becoming equal to each other in a high gray scale area.

4. The image processing apparatus according to claim 1, further comprising:
a quantized reference unit configured to output a weighted average value obtained by the sum of products of the quantized states of the neighboring pixels of the target pixel; and
a history value calculation unit configured to calculate a history value based on the weighted average value,
the threshold setting unit setting the threshold value according to the quantized states and the history value.

5. The image processing apparatus according to claim 4, further comprising a history coefficient setting unit configured to set a history coefficient according to the multi-level image data of the target pixel,
the history value calculation unit calculating the history value based on the weighted average value and the history coefficient.

6. The image processing apparatus according to claim 5, further comprising a variable threshold setting unit configured to set a variable threshold value according to the multi-level image data of the target pixel,
the threshold setting unit setting the threshold according to the quantized states, the history value, and the variable threshold value.

7. The image processing apparatus according to claim 5, wherein the history coefficient obtained according to the image data of the target pixel is high in a low gray scale area of the image data and is low in a high gray scale area of the image data.

8. An image forming system, comprising:
the image processing apparatus according to claim 1;
an image input apparatus configured to input the multi-level image data of the target pixel to the image processing apparatus; and
an image forming apparatus configured to form the N-level image data,
wherein the image processing apparatus is incorporated in one of the image input apparatus and the image forming apparatus.

9. An image processing apparatus configured to quantize multi-level image data of M gray levels into N-level image data (M>N>2) by using one of a multi-level error diffusion technique and a multi-level minimized average error method,
the image processing apparatus comprising:
an N-level processing unit configured to execute N-level processing when a large dot is output at a position of a pixel adjacent to a target pixel; and
a binary processing unit configured to execute binary processing when a dot other than the large dot is output at a position of a pixel adjacent to the target pixel,
wherein the image processing apparatus uses a weight matrix when performing error diffusion.

10. The image processing apparatus according to claim 9, wherein the weight matrix includes a coefficient of 0 or below at a position of a neighboring pixel of the target pixel.

11. The image processing apparatus according to claim 9, wherein a weight matrix including a coefficient of 0 or below at a position of a neighboring pixel of the target pixel is used when a large dot is output through binary processing, and a normal weight matrix is used when a dot-off hole is output through binary processing or when N-level processing is executed.

12. The image processing apparatus according to claim 10, wherein the multi-level image data is quantized into the N-level image data (M>N>2) using the multi-level error diffusion method to form an image by using a dot corresponding to each pixel included in the N-level image data,
the image processing apparatus further comprising:
an adder configured to add the sum of products of weighted error values of neighboring pixels already quantized to multi-level image data of a target pixel to output a correction value;
a quantization memory configured to store quantized states of the neighboring pixels of the target pixel;
a threshold setting unit configured to set a threshold value according to the quantized states stored in the quantization memory;
a comparison and determination unit configured to compare the threshold with the correction value and determine the N-level image data;
a subtractor configured to obtain an error generated with the N-level image data;
an error diffusion unit configured to weight and diffuse the error to the neighboring pixels of the target pixel by using the weight matrix including the coefficient of 0 or smaller at the pixel positions of the neighboring pixels of the target pixel; and
an error memory configured to store the weighted and diffused error.

13. The image processing apparatus according to claim 9, wherein the multi-level image data is quantized into the N-level image data (M>N>2) using the multi-level error diffusion method to form an image by using a dot corresponding to each pixel included in the N-level image data,
the image processing apparatus further comprising:
an adder configured to add the sum of products of weighted error values of neighboring pixels already quantized to multi-level image data of a target pixel to output a correction value;
a quantization memory configured to store quantized states of the neighboring pixels of the target pixel;
a threshold setting unit configured to set a threshold value according to the quantized states stored in the quantization memory;
a comparison and determination unit configured to compare the threshold value with the correction value and determine the N-level image data;
a subtractor configured to obtain an error generated with the N-level image data;
an error diffusion coefficient setting unit configured to select one weight matrix from multiple weight matrixes according to the quantized states of the neighboring pixels of the target pixel and the N-level image data;
an error diffusion unit configured to weight and diffuse the error to the neighboring pixels of the target pixel by using the selected weight matrix; and
an error memory configured to store the weighted and diffused error.

14. The image processing apparatus according to claim 11, wherein the multi-level image data is quantized into the N-level image data (M>N>2) using the multi-level error diffusion method to form an image by using a dot corresponding to each pixel included in the N-level image data,
the image processing apparatus further comprising:
an adder configured to add the sum of products of weighted error values of neighboring pixels already quantized to multi-level image data of a target pixel to output a correction value;
a quantization memory configured to store quantized states of the neighboring pixels of the target pixel;
a variable threshold setting unit configured to set a variable threshold value according to the multi-level image data of the target pixel;
a threshold setting unit configured to set a threshold value according to the quantized states stored in the quantization memory and the variable threshold value;
a comparison and determination unit configured to compare the threshold value with the correction value and determine the N-level image data;
a subtractor configured to obtain an error generated with the N-level image data;
an error diffusion unit configured to weight and diffuse the error to the neighboring pixels of the target pixel by using the weight matrix including the coefficient of 0 or smaller at the pixel positions of the neighboring pixels of the target pixel; and
an error memory configured to store the weighted and diffused error.

15. The image processing apparatus according to claim 14, wherein the variable threshold value obtained according to the multi-level image data of the target pixel includes N-1 threshold values,
the N-1 threshold values being different in low and medium gray scale area, gradually becoming closer to each other as the gray scale becomes higher, and becoming equal to each other in a high gray scale area.

16. The image processing apparatus according to claim 11, wherein the multi-level image data is quantized into the N-level image data (M>N>2) using the multi-level error diffusion method to form an image by using a dot corresponding to each pixel included in the N-level image data,
the image processing apparatus further comprising:
an adder configured to add the sum of products of weighted error values of neighboring pixels already quantized to multi-level image data of a target pixel to output a correction value;
a quantization memory configured to store quantized states of the neighboring pixels of the target pixel;
a variable threshold setting unit configured to set a variable threshold value according to the multi-level image data of the target pixel;
a threshold setting unit configured to set a threshold value according to the quantized states stored in the quantization memory and the variable threshold value;
a comparison and determination unit configured to compare the threshold value with the correction value and determine the N-level image data;
a subtractor configured to obtain an error generated with the N-level image data;
an error diffusion coefficient setting unit configured to select one weight matrix among multiple weight matrixes according to the quantized states of the neighboring pixels of the target pixel and the N-level image data;
an error diffusion unit configured to weight and diffuse the error to the neighboring pixels of the target pixel by using the selected weight matrix; and
an error memory configured to store the weighted and diffused error.

17. The image processing apparatus according to claim 11, wherein the one weight matrix selected from the multiple weight matrixes is a matrix including a coefficient of 0 or smaller at the positions of the neighboring pixels of the target pixel while another weight matrix of the multiple weight matrixes is a matrix including a coefficient being large to positive error at the pixel positions of the neighboring pixels of the target pixel and the coefficient gradually becoming smaller as becoming farther from the target pixel.

18. An image forming system, comprising:
the image processing apparatus according to claim 9;
an image input apparatus configured to input the multi-level image data of the target pixel to the image processing apparatus; and
an image forming apparatus configured to form the N-level image data,
wherein the image processing apparatus is incorporated in one of the image input apparatus and the image forming apparatus.

19. A computer program product comprising a computer-usable medium having computer-readable program codes embodied in the medium that, when executed, causes a computer to execute an image processing method comprising:
adding the sum of products of weighted error values of neighboring pixels already quantized to multi-level image data of a target pixel to output a correction value;
storing quantized states of the neighboring pixels of the target pixel;
setting a threshold value according to the stored quantized states;
comparing the threshold value with the correction value and determine the N-level image data;
obtaining an error generated with the N-level image data;
weighting and diffusing the error to the neighboring pixels of the target pixel; and
storing the weighted and diffused error.
